(19) United States
(12) Patent Application Publication
(10) Pub. No.: US 2014/0038285 A1
(43) Pub. Date: Feb. 6, 2014

(54) METHOD OF CORRELATED MUTATIONAL ANALYSIS TO IMPROVE THERAPEUTIC ANTIBODIES

(71) Applicant: Gunasekaran Kannan, Newbury Park, CA (US)

(72) Inventor: Gunasekaran Kannan, Newbury Park, CA (US)

(73) Assignee: AMGEN INC., THOUSAND OAKS, CA (US)

(21) Appl. No.: 14/004,392

(22) PCT Filed: Mar. 9, 2012
(86) PCT No.: PCT/US12/28596

§ 371 Date: Oct. 15, 2013

Related U.S. Application Data
(60) Provisional application No. 61/451,929, filed on Mar. 11, 2011.

(51) Int. Cl. G06F 19/22

(52) U.S. Cl. CPC G06F 19/22
USPC 435/328; 435/252.3; 435/252.31; 435/252.33; 435/254.2; 435/254.21; 435/254.22; 530/387.3; 536/23.53

(57) ABSTRACT

A method of improving antibody manufacturability or developability through a computational approach.

### CROSS-REFERENCE TO RELATED APPLICATIONS

This application claims the benefit of U.S. Provisional Application No. 61/451,929, filed Mar. 11, 2011, which is hereby incorporated by reference.

### BACKGROUND OF THE INVENTION

Antibodies have become the modality of choice within the Biopharma industry because they have proven to be very effective and successful therapeutic molecules for treatment of various diseases. With increasing number of antibody-based therapeutic molecules entering into clinical studies, assessing and improving a candidate antibody at the early phase of discovery has become more important. The process has been called by different terminologies such as molecule, manufacturability, and developability assessments and quality-by-design. In this regard, application of computational methods for antibody engineering has emerged as a valuable tool for efficient experimental design in order to reduce costs and time invested.

Antibodies belong to immunoglobulin class of proteins which includes IgG, IgA, IgE, IgM, and IgD. The most abundant immunoglobulin class in human serum is IgG whose schematic structure is shown in the FIG. 1 (Deisenhofer 1981; Huber 1984; Roux 1999). The IgG structure has four chains, two light and two heavy chains, and each light chain has two domains and each heavy chain has four domains. The antigen binding site is located in the Fab region (Fragment antigen binding) which contains a variable light (VL) and heavy (VH) chain domains as well as constant light (CL) and heavy (CH1) chain domains. The CH2 and CH3 domain region of the heavy chain is called Fc (Fragment crystallizable). The number of hinge disulfide bonds varies among the immunoglobulin subclasses (Papadea and Check 1989). The FcRn binding site is located in the Fc region of the antibody (Martin et al. 2001). The variable domains VL and VH can be fused together through a linker polypeptide and this leads to scFv—single chain fragment variable. The scFv itself, though lacking the Fc region that provides extended serum half-life, has many applications in cancer. It is claimed that the smaller size of scFv permits high penetration into tumor cells.

Attempts have been made to improve pharmaceutical properties such as solubility and stability of antibodies or variable domain fragments. These attempts include mutating residues to the most frequent ones based on the alignment of homologous antibody sequences, engineering β-turns with amino acids that have high propensity to form turn conformation, increasing hydrophilicity of the solvent exposed residues, adding additional hydrogen bonds or disulfide bonds, library based screening of large number of variants, and directed evolution by in vitro or in vivo methods. Methods that combine many of these approaches have also been reported in the literature (Monsellier and Bedouelle 2006; Wang et al. 2009). In another engineering method, the complementary determining region from a very poorly expressed antibody or scFv were grafted onto a preferred framework that has favorable biophysical properties (Jung et al. 1999). Some of these approaches are reviewed in the published articles (Worn and Pluckthun 2001; Honegger 2008)). Although each of these methods alone or in combination has been met with limited success in increasing stability, none of them are guaranteed to work in all cases of antibodies against different targets.

Provided herein is a simplified method that has improved properties consistently in the antibodies against multiple targets. More importantly, the benefits go beyond improving stability alone, such as in reducing level of aggregation, higher resistance to oxidation, eliminating precipitation when pH is changed from 5 to 7, decreasing viscosity, and improving expression level.

### SUMMARY OF THE INVENTION

A method of improving antibody manufacturability or developability through a computational approach is described herein. The method described here deals with (i) identification of pair-wise conserved residue positions based on the physiochemical properties of the residues, (ii) evaluating how the antibody sequence of interest deviates from that pair-wise conservation, and (iii) substituting the deviating position(s) with amino acids found at the equivalent positions in germline or related germline sequences. This method often identifies issues with germline residues and suggests they be replaced with related germline residues. This computational method has been applied to more than 10 antibodies against various antigens. The suggested single and combinations of point mutations have led to consistent improvement in one or more physical and chemical properties along with expression.

In a first aspect, provided herein is a method of improving one or more characteristics of an antigen binding protein comprising an antibody variable domain of interest. The method comprises: a) identification of pair-wise conserved residue positions within a variable domain framework based on a physiochemical property of the residues; b) determining how the antibody variable domain of interest framework amino acid sequence deviates from the pair-wise conserved residue positions identified in a); c) substituting one or more amino acid residues determined to be deviations from b) with amino acids found at equivalent positions in germline or related-germline sequences.

Pair-wise conserved residues can be identified by: i) assigning a germline subtype to the antibody variable domain of interest; ii) aligning framework regions of multiple variable domains belonging to the same germline subtype identified in (i); iii) classifying the amino acid at each position within an aligned variable domain as small hydrophobic, aromatic, neutral polar, positively charged, negatively charged, or glycine/deletion; iv) calculating a conservation score for each pair-wise position; and v) determining co-varying or correlated mutational pairs or pair-wise conserved residue positions based on a threshold calculation.

A preferred method of determining a conservation score includes calculating number of pairs belonging to the same physiochemical characteristics and subtracting that sum with the number of pairs belonging to different physiochemical characteristics. For example, when the twenty amino acids are classified into two groups hydrophobic (H) and polar (P), conservation score=(No. of HiHj+No. of PiPj)−No. of HiPj, where i=1, N−1; j=i+1 to N; N=length of the target sequence of interest.

Deviations within the antibody variable domain of interest can be determined by comparing amino acid pairs from the target sequence of interest with the correlated or covarying pairs identified from the multiple sequence alignment. In other words, deviations in the target sequence are those that differ from the observed pattern of pair-wise conserved positions that are identified using the database of variable domain sequences. One or more of the amino acids determined to be deviations can be substituted with an amino acid found at that position in the germline sequence or a related germline sequence. In certain embodiments, all the amino acids determined to be deviations are substituted with an amino acid found at that position in the germline sequence or a related germline sequence.

In preferred embodiments, the antigen binding protein comprises a heavy chain variable domain and a light chain variable domain, e.g., an scFv or an antibody. The heavy chain variable domain and/or light chain variable domain can be a human variable domain. In certain embodiments, the antigen binding protein is a human antibody.

The method is useful for improving one or more characteristics of an antigen binding protein. In preferred embodiments, the antigen binding protein is a therapeutic protein. Characteristics that may be altered by the method include improved expression within transiently- or stably-transfected host cells, increased thermostability, reduced aggregation propensity, increased in vivo half-life, increased storage shelf life, increased folding efficiency, increased resistance to light induced oxidation, reduced clippings during storage conditions, reduced viscosity, reduced sensitivity to pH changes, and reduced chemical and physical degradations.

In a second aspect, described herein are antigen binding proteins improved by a method of the first aspect.

In a third aspect, described herein are isolated nucleic acids encoding an antibody variable domain of an antigen binding protein improved by the method of the first aspect. In preferred embodiments, the method comprised substituting one or more residues within the antibody variable domain with a germline or related-germline residue.

In a fourth aspect, described herein are host cells comprising an isolated nucleic acid of the third aspect.

### BRIEF DESCRIPTION OF THE DRAWINGS

FIG. 1: Schematic structure of an antibody. Schematic diagram of IgG1 antibody with the domains indicated. The IgG1 antibody is a Y-shaped tetramer with two heavy chains (longer length) and two light chains (shorter length). The two heavy chains are linked together by disulfide bonds (—S—S—) at the hinge region. Fab—fragment antigen binding, Fc—fragment crystallizable, VL—variable light chain domain, VH—variable heavy chain domain, CL—constant (no sequence variation) light chain domain, CH1—constant heavy chain domain 1, CH2—constant heavy chain domain 2, CH3—constant heavy chain domain 3.

FIG. 2. Ribbon representation of crystal structure of a variable domain fragment of an antibody showing the complementary determining region (lightly shaded) and framework region (FR). The variable domain consists of light (VL) and heavy (VH) chains. The complementary determining regions (CDRs) have high sequence variability and are involved in binding. The framework region consists of mainly β-strand secondary structure and turns. The VL domain contacts the VH domain leading to a large interface region.

FIG. 3. Flow chart of the scheme used to analyze correlated amino acid pairs based on the physiochemical properties (hydrophobic, aromatic, neutral polar, positively charged, negatively charged, etc) and identify amino acid substitutions to rectify the covariance violations. The amino acid substitutions to fix the violations are identified through examination of the residues at the equivalent positions in the closely related germline sequences. Further, structural context and frequency of occurrence of amino acids at the equivalent position in the database is also taken into account to further narrow down to single amino acid substitution.

FIG. 4. Alignment of a target antibody's variable (a) heavy chain and (b) light chain domain sequence with the human germline sequences. Only the top 5 closely related germlines based on the percentage of identity to the target sequence is shown here in the alignment. Positions identified through correlated mutational analysis for modifications are encircled.

FIG. 5. Part of the output of a computer program that implements the method described here in order to identify the correlated mutational pairs and violations in the target antibody sequence. The position in the target sequence of interest and it's covarying positions as determined using the conservation score and threshold is shown. The number inside the parenthesis indicates the conservation score. A plus (+) indicates the pattern is similar to that observed in the known antibody sequences; a minus (−) indicates the pattern differs from that observed in the known antibody sequences [covariance violation or deviation]. The fraction shown inside the square brackets indicates entropy—a measure of sequence variability at that position. Note that in the case of F51, it is correlated to positions V13, A19, I21, C23, L42, P45, P49, L52, I53, V63, P64, L78, I80, V83, V90, and C93. However, F51 is a violation (not correlated) in every single case as indicated by the minus (“−”) sign. This suggests that Phe at position 51 should be mutated to small hydrophobic residues.

FIG. 6. Transient expression of the parental antibody and mutants identified through correlated mutational analysis. Up to 20 fold improvement in expression is seen for the variants compared to the parental molecule.

FIG. 7a. Differential scanning calorimetric profiles of the parental antibody and mutants identified through correlated mutational analysis. The variants exhibit equal or improved thermal stability compared to the parental. In particular, the variant that has the maximum number of mutations show highest improvement in thermal stability.

FIG. 7b. Binding analysis of the parental antibody and its variants using Kinexa. The parental antibody and the variants exhibit similar (within two fold difference in Kd) binding characteristics.

FIG. 8. Alignment of a target antibody's variable (a) heavy chain and (b) light chain domain sequence with the human germline sequences. Only the top 5 closely related germlines based on the percentage of identity to the target sequence is shown here in the alignment. Positions identified through the correlated mutational analysis for modifications are encircled.

FIG. 9. List of variants made and analyzed for the second target antibody. Note that Y231F mutation was not suggested by the correlated mutational analysis.

FIG. 10. Transient expression level of the parental antibody and its variants in scFv-Fc format. (a) and (b) corresponds to the transient expression level and purified yield, respectively, in 250 ml production run. (c) corresponds to the repeated expression tests in 10 ml production run. The variants had equal or better expression compared to the parental antibody. In particular, the variant that had maximum number of mutations showed highest improvement in the expression level.

FIG. 11. Aggregation level as measured by the SEC for the parental antibody and its variants, in the scFv-Fc format, which were designed based on the correlated mutational analysis.

FIG. 12. Thermal stability profiles of the parental antibody and its variants in the (a) scFv-Fc format and (b) IgG format. All the variants show equal or improved thermal stability compared to the parental antibody. In particular, the variant that has the maximum number of mutations show highest improvement in the thermal stability (both enthalpy and melting temperature improved).

FIG. 13. (a) FACS based binding analysis of the parental antibody and its variants. All the variants show similar binding profiles in this analysis as indicated by the geometric mean analysis shown in (b).

FIG. 14. (a) Expression level of the third target antibody and its variants identified through correlated mutational analysis. The variants show 3 to 4 fold improved expression level compared to the parental antibody. The variant that has maximum number of mutations show highest improvement in the expression level. (b) In this particular case, binding analysis reveals the variant that has maximum number of mutations show slightly lower IC50 value.

FIG. 15. Consistent with the other two stated examples, the variants identified through correlated mutational analysis show improved thermal stability. The design that has the maximum number of mutations (F 15) shows highest improvement in the thermal stability.

FIG. 16. Expression titer level of the fourth target parental antibody and its variants designed through correlated mutational analysis. Incremental improvement in the expression level was seen as the number of mutations is increased.

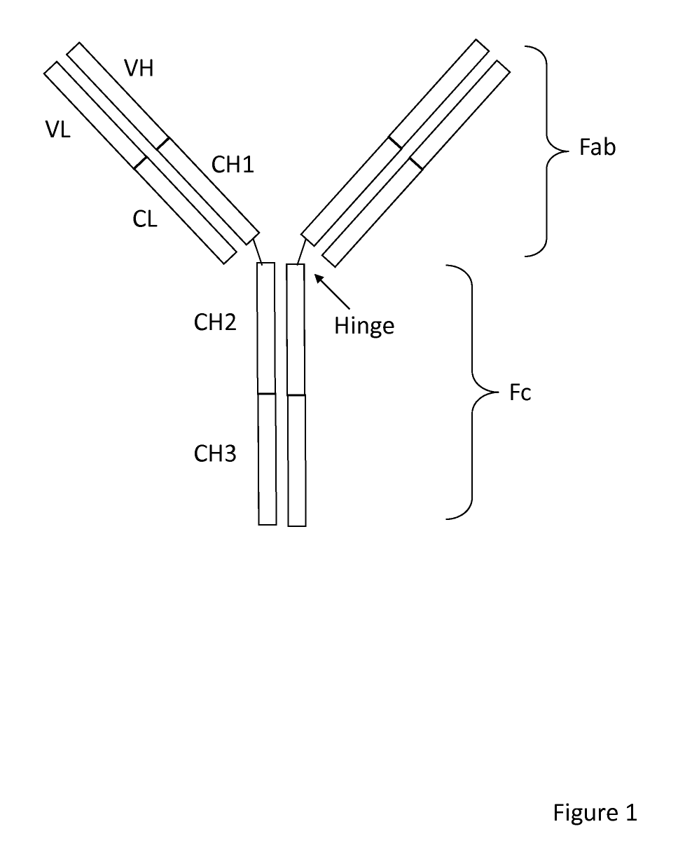

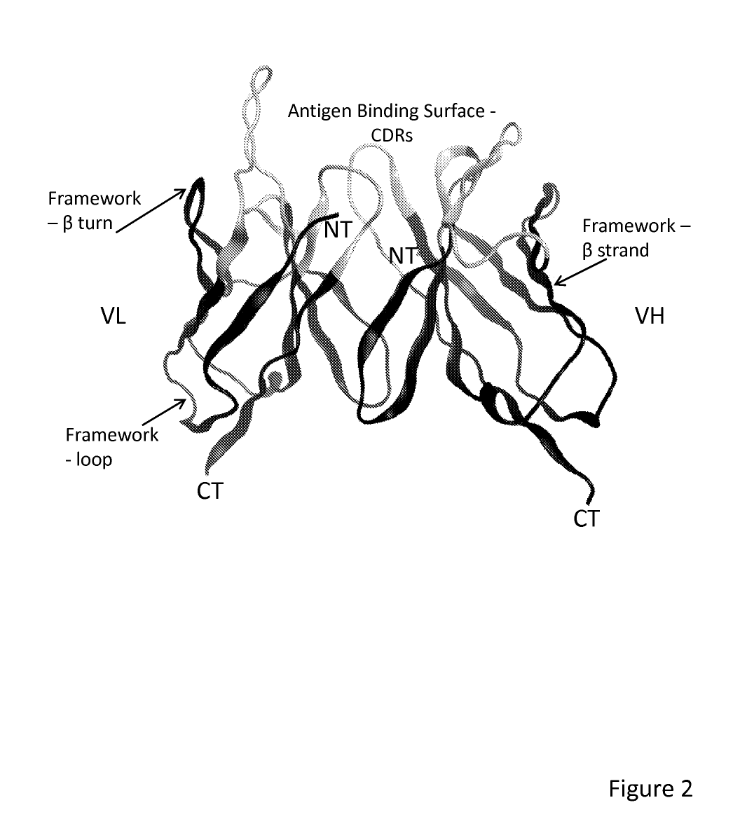

### DEFINITIONS

“Antigen binding protein” is a protein or polypeptide that contains one or more antibody variable domains and specifically binds an antigen. In preferred embodiments, the antigen binding protein comprises two variable domains that interact and together specifically bind an antigen. Embodiments of antigen binding proteins comprise antibodies and fragments thereof, as variously defined herein, that specifically bind an antigen. Antigen binding proteins may optionally include one or more post-translational modification.

“Specifically binds” as used herein means that the antigen binding protein preferentially binds the antigen over other proteins. In some embodiments “specifically binds” means the antigen binding protein has a higher affinity for the antigen than for other proteins. Antigen binding proteins that specifically bind an antigen may have a binding affinity for the antigen of less than or equal to 1×10⁻⁷ M, less than or equal to 2×10⁻⁷ M, less than or equal to 3×10⁻⁷ M, less than or equal to 4×10⁻⁷ M, less than or equal to 5×10⁻⁷ M, less than or equal to 6×10⁻⁷ M, less than or equal to 7×10⁻⁷ M, less than or equal to 8×10⁻⁷ M, less than or equal to 9×10⁻⁷ M, less than or equal to 1×10⁻⁸M, less than or equal to 2×10⁻⁸M, less than or equal to 3×10⁻⁸ M, less than or equal to 4×10⁻⁸M, less than or equal to 5×10⁻⁸ M, less than or equal to 6×10⁻⁸ M, less than or equal to 7×10⁻⁸ M, less than or equal to 8×10⁻⁸ M, less than or equal to 9×10⁻⁸ M, less than or equal to 1×10⁻⁹ M, less than or equal to 2×10⁻⁹ M, less than or equal to 3×10⁻⁹ M, less than or equal to 4×10⁻⁹ M, less than or equal to 5×10⁻⁹ M, less than or equal to 6×10⁻⁹ M, less than or equal to 7×10⁻⁹ M, less than or equal to 8×10⁻⁹ M, less than or equal to 9×10⁻⁹ M, less than or equal to 1×10⁻¹⁰ M, less than or equal to 2×10⁻¹⁰M, less than or equal to 3×10⁻¹⁰ M, less than or equal to 4×10⁻¹⁰ M, less than or equal to 5×10⁻¹⁰ M, less than or equal to 6×10⁻¹⁰ M, less than or equal to 7×10⁻¹⁰ M, less than or equal to 8×10⁻¹⁰ M, less than or equal to 9×10⁻¹⁰ M, less than or equal to 1×10⁻¹¹ M, less than or equal to 2×10⁻¹¹ M, less than or equal to 3×10⁻¹¹ M, less than or equal to 4×10⁻¹¹ M, less than or equal to 5×10⁻¹¹ M, less than or equal to 6×10⁻¹¹ M, less than or equal to 7×10⁻¹¹ M, less than or equal to 8×10⁻¹¹ M, less than or equal to 9×10⁻¹¹ M, less than or equal to 1×10⁻¹² M, less than or equal to 2×10⁻¹² M, less than or equal to 3×10⁻¹² M, less than or equal to 4×10⁻¹² M, less than or equal to 5×10⁻¹² M, less than or equal to 6×10⁻¹² M, less than or equal to 7×10⁻¹² M, less than or equal to 8×10⁻¹² M, or less than or equal to 9×10⁻¹²M.

“Antibody” as meant herein, is a protein containing at least two variable regions, in many cases a heavy and a light chain variable region. Thus, the term “antibody” encompasses single chain Fv antibodies (scFv, which contain heavy and light chain variable regions joined by a linker), Fab, F(ab)₂′, Fab′, scFv:Fc antibodies (as described in Carayannopoulos and Capra, Ch. 9 in Fundamental Immunology, 3^{rd} ed., Paul, ed., Raven Press, New York, 1993, pp. 284-286) or full length antibodies containing two full length heavy and two full length light chains, such as naturally-occurring IgG antibodies found in mammals. Id. Such IgG antibodies can be of the IgG1, IgG2, IgG3, or IgG4 isotype and can be human antibodies. The portions of Carayannopoulos and Capra that described the structure of antibodies are incorporated herein by reference. Further, the term “antibody” includes dimeric antibodies containing two heavy chains and no light chains such as the naturally-occurring antibodies found in camels and other dromedary species and sharks. See, e.g., Muldermans et al., 2001, J. Biotechnol. 74:277-302; Desmyter et al., 2001, J. Biol. Chem. 276:26285-90; Streltsov et al. (2005), Protein Science 14: 2901-2909. An antibody can be monospecific (that is, binding to only one kind of antigen) or multispecific (that is, binding to more than one kind of antigen). In some embodiments, an antibody can be bispecific (that is, binding to two different kinds of antigen). Further, an antibody can be monovalent, bivalent, or multivalent, meaning that it can bind to one or two or more antigen molecules at once. Some of the possible formats for such antibodies include monospecific or bispecific full length antibodies, monospecific monovalent antibodies (as described in International Application WO 2009/089004 and US Publication 2007/0105199, the relevant portions of which are incorporated herein by reference), bivalent monospecific or bispecific dimeric scFv-Fc's, monospecific monovalent scFv-Fc/Fc's, and the multispecific binding proteins and dual variable domain immunoglobulins described in US Publication 2009/0311253 (the relevant portions of which are incorporated herein by reference), among many other possible antibody formats.

“Antibody variable domain” The variable regions of the heavy and light chains of an antibody typically exhibit the same general structure of relatively conserved framework regions (FR) joined by three hypervariable regions, i.e., the complementarity determining regions or CDRs. The CDRs are primarily responsible for antigen recognition and binding. The CDRs from the two chains of each pair are aligned by the framework regions, enabling binding to a specific epitope. From N-terminal to C-terminal, both light and heavy chains comprise the domains FR1, CDR1, FR2, CDR2, FR3, CDR3, and FR4. The assignment of amino acids to each domain is in accordance with the definitions of Kabat (Martin, A. C. R. (2010) Protein Sequence and Structure Analysis of Antibody Variable Domains. In: Antibody Engineering Lab Manual Volume 2 (2^{nd} Edition), ed.: Duebel, S. and Kontermann, R., Springer-Verlag, Heidelberg).

“Variable domain framework” region is as defined by the Kabat definition. However, structure based definitions such as Chothia and AHo could also be used to define the framework region. For the recent review on known antibody sequence numbering schemes see Martin, A. C. R. (2010) Protein Sequence and Structure Analysis of Antibody Variable Domains. In: Antibody Engineering Lab Manual Volume 2 (2^{nd} Edition), ed.: Duebel, S. and Kontermann, R., Springer-Verlag, Heidelberg.

“Heavy chain variable domain” is a variable domain derived from a heavy chain locus. This domain includes antigen binding sites or paratope and the amino acid sequence may vary depending on the target antigen or binding sites (epitope) on the target.

“Light chain variable domain” is a variable domain derived from a light chain locus. This domain includes antigen binding sites or paratope and the amino acid sequence may vary depending on the target antigen or binding sites (epitope) on the target.

“Human light chain variable domain” is a variable domain derived from a human light chain locus. This domain includes antigen binding sites or paratope and the amino acid sequence may vary depending on the target antigen or binding sites (epitope) on the target.

“Human heavy chain variable domain” is a variable domain derived from a human heavy chain locus. This domain includes antigen binding sites or paratope and the amino acid sequence may vary depending on the target antigen or binding sites (epitope) on the target.

“Human antibody” is an antibody comprising a light chain and heavy chain wherein both the variable and constant regions are derived from a human locus.

“Grouping or classifying of amino acids based on the physiochemical properties” Amino acids are classified based on their physiochemical properties. In one grouping method, the naturally occurring twenty amino acids and the amino acid deletion in the sequence are classified into 6 groups—small hydrophobic: Ala, Ile, Leu, Met, Cys, Val, and Pro; aromatic: Phe, Trp, and Tyr; neutral polar: Asn, Gln, Ser, Thr; negatively charged: Asp and Glu; positively charged: Lys, Arg and H is; no side chain: Gly and deletion. In another grouping method the amino acids and the deletion are classified into four groups—hydrophobic: Ala, Ile, Leu, Met, Cys, Val, Pro, Phe, Trp, and Tyr; polar: Asn, Gln, Ser, and Thr; charged: Asp, Glu, Lys, Arg and His; no side chain: Gly and deletion. In yet another grouping method, the amino acid Cys may be considered as hydrophobic as well as neutral polar residue, and the His may be considered as polar amino acid.

“Conservation Score” is defined as the sum of pairs belonging to the same physiochemical characteristics and subtracting that with the sum of pairs belonging to different physiochemical characteristics. For example, for a six group classification, Conservation score=No. of Xi Xj−No. of Xi Yj, where, X and Y may be small hydrophobic, aromatic, neutral polar, positively charged, negatively charged, or glycine/deletion amino acids, but X not equal to Y; i=1, N−1; j=i+1, N; N=length of the target sequence variable domain.

“Threshold” or cutoff is defined as conservation score×100 divided by the total number of known variable domain sequences (from Kabat/IMGT databased) used in the multiple sequence alignments. In certain embodiments the threshold is at least 60%, at least 65%, at least 70%, at least 75%, at least 80%, at least 85%, at least 90%, or at least 95%. In preferred embodiments, the multiple sequence alignment comprises at least 5 known variable domains, at least 10 known variable domains, at least 20 known variable domains, at least 50 known variable domains, at least 75 known variable domains, at least 100 known variable domains, at least 150 known variable domains, at least 200 known variable domains, at least 250 known variable domains, at least 300 known variable domains, at least 400 known variable domains, at least 500 known variable domains, at least 600 known variable domains, at least 700 known variable domains, at least 800 known variable domains, at least 900 known variable domains, at least 1000 known variable domains, at least 1500 known variable domains, at least 2000 known variable domains, at least 3000 known variable domains, at least 4000 known variable domains, or at least 5000 known variable domains.

“Germline sequence” is defined as the human germline sequence that has highest percentage of sequence identity with the given antibody sequence. The germline sequence is identified based on comparison of the given antibody sequence with the human germline sequence database.

“Related germline sequences” are the human germline sequences that share greater than 80% sequence identity with the given antibody sequence. Often, the related germline refers to the top 5 human germline sequences that have highest percentage of sequence identity with the given antibody sequence. Sometimes, the percentage cutoff used to identify the related germline sequences is lowered from 80% to 70%, when there are fewer than 5 germline sequences that share greater than 80% identity with the given target antibody sequence.

Databases used: Essentially any database containing antibody variable domain sequences can be used. Preferred databases include the human germline sequence database, Kabat (Wu and Kabat 1970) antibody sequence database and/or IMGT antibody sequence database. These databases may be further processed to generate light chain and heavy pair database, which is used to analyze correlated pair-wise mutations in the VL/VH interface.

“Correlated mutation, pair-wise conserved residue positions, or covariance” is defined as concerted change in the physiochemical nature of amino acid pairs. All possible position-wise pairs in the given antibody sequence are considered for analyzing correlated mutational behavior. For example, position 1 in the sequence is compared with position 2, and then with position 3, and then with position 4, and so on.

“Deviation from correlated mutation, pair-wise conserved residue positions, or covariance” is defined as amino acids pairs in the target sequence that differ from the observed pattern of pair-wise conserved residue positions that are identified using the multiple sequence alignment of known variable domain sequences. For example, position i and j in the target sequence have different physiochemical characteristics (e.g., i is hydrophobic and j is polar amino acid) whereas in the database the equivalent position i and j belongs to the same physiochemical grouping (e.g., both i and j belongs to hydrophobic group of amino acids).

“Equivalent positions” are identified based on the sequence alignments. Two positions belonging to two different antibodies are considered equivalent if, when viewed in a traditional sequence alignment, one is positioned under the other amino acid when aligning the two sequences.

“Aligning sequences” An example of a useful algorithm is PILEUP. PILEUP creates a multiple sequence alignment from a group of related sequences using progressive, pairwise alignments. It can also plot a tree showing the clustering relationships used to create the alignment. PILEUP uses a simplification of the progressive alignment method of Feng & Doolittle, 1987, J. Mol. Evol. 35:351-360; the method is similar to that described by Higgins and Sharp, 1989, CABIOS 5:151-153. Useful PILEUP parameters including a default gap weight of 3.00, a default gap length weight of 0.10, and weighted end gaps.

An additional useful algorithm is gapped BLAST as reported by Altschul et al., 1993, Nucl. Acids Res. 25:3389-3402. Gapped BLAST uses BLOSUM-62 substitution scores; threshold T parameter set to 9; the two-hit method to trigger ungapped extensions, charges gap lengths of k a cost of 10+k; Xᵤ set to 16, and X_{g} set to 40 for database search stage and to 67 for the output stage of the algorithms. Gapped alignments are triggered by a score corresponding to about 22 bits.

Another algorithm commonly used for multiple sequence alignment is Clustal or ClustalW (Higgins and Sharp 1988). Clustal parameters include gap penalty. The other commonly used algorithm is called MUSCLE.

“Improved expression” is defined herein as increased expression of an antigen binding protein improved by the method of the invention in a host cell as compared to the antigen binding protein prior to improvement. The host cell may be transiently transfected or stably transfected with one or more nucleic acids encoding the components of the antigen binding protein. Improved expression may be at least 5% improvement, at least 10% improvement, at least 15%, at least 20% improvement, at least 25%, improvement, at least 30% improvement, at least 35% improvement, at least 40% improvement, at least 45% improvement, at least 50% improvement, at least 55% improvement, at least 60% improvement, at least 65% improvement, at least 70% improvement, at least 75% improvement, at least 80% improvement, at least 85% improvement, at least 90% improvement, at least 95% improvement, at least 100% improvement or 2-fold, at least 3-fold, at least 4-fold, at least 5-fold, at least 6-fold, at least 7-fold, at least 8-fold, at least 9-fold, at least 10-fold, at least 15-fold, at least 20-fold, at least 25-fold, at least 30-fold, at least 35-fold, at least 40-fold, at least 45-fold, at least 50-fold, at least 55-fold, at least 60-fold, at least 65-fold, at least 70-fold, at least 75-fold, at least 80-fold, at least 85-fold, at least 90-fold, at least 95-fold, or at least 100-fold.

“Improved thermal stability” is defined herein as an increase in the melting temperature (Tm) of the antigen binding protein improved by the method of the invention as compared to the antigen binding protein prior to improvement. The improvement in thermal stability may be at least 1° C., at least 2° C., at least 3° C., at least 4° C., at least 5° C., at least 6° C., at least 7° C., at least 8° C., at least 9° C., or at least 10° C., Methods of measuring the Tm of an antigen binding protein include, but are not limited to, Differential Scanning calorimetry (DSC), Differential Scanning Florimetry (DSF), Circular Dichroism (CD), and far- and near-UV CD spectroscopy.

### DETAILED DESCRIPTION

Described herein are methods of improving antibody manufacturability or developability through a computational approach. Ideally, a candidate antibody molecule should express well, should not have any aggregation issue, should have higher physical and chemical stability, and other improved biophysical properties such as resistance to light-induced oxidation. The method described here deals with (i) identification of pair-wise conserved residue positions based on the physiochemical properties, (ii) evaluating how the antibody sequence of interest deviates from the observed pair-wise conservation (“violations”), and (iii) substituting the deviating position(s) with amino acids found in the germline or related germline sequences preserving sequence and structural context in order to reduce immunogenicity.

The observed violations are not limited to non-germline residues and, moreover, the method often identifies issues with germline residues and suggests they be replaced with related germline residues. The method has been applied to more than a dozen antibodies binding to different antigens and observed consistent improvement in thermal stability and transient expression in 293 and CHO cells. Often, the antibody construct that has all the violations fixed show maximum improvement in thermal stability and expression. This suggests that the violations identified by methods described herein are meaningful ones and the success is not the outcome of random chance. In general, the observed improvement in thermal stability varies from 1° C. to 12° C. depending on the molecule and number of violations fixed, and the expression improvement varies from 2-fold to 100-fold in transient expression.

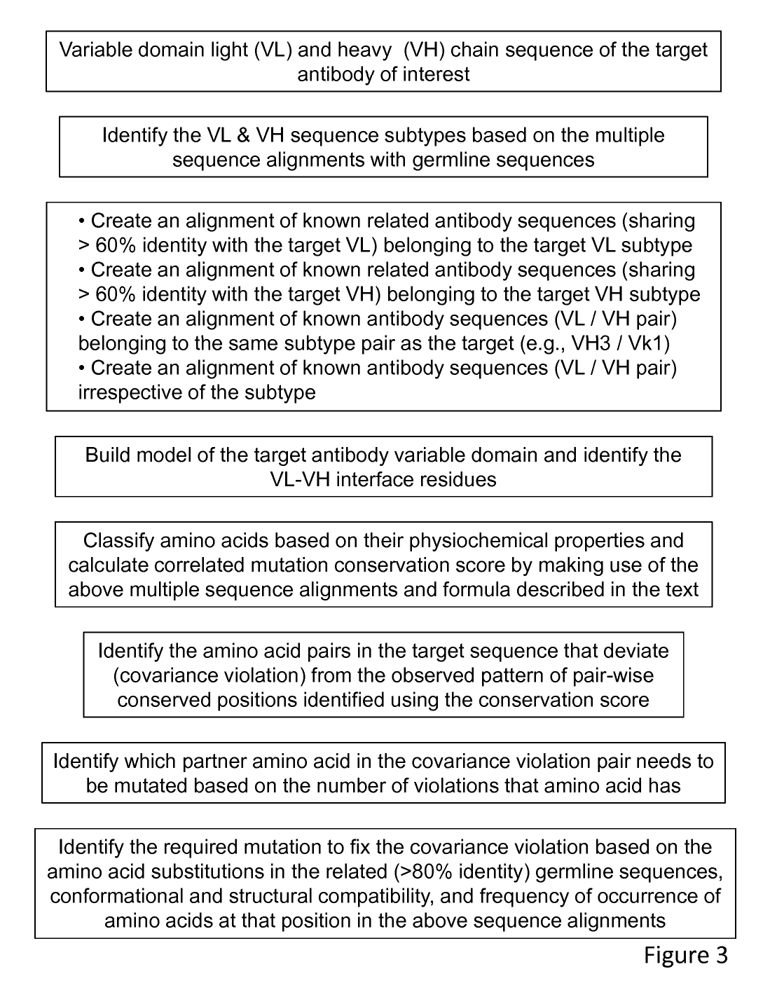

The first step of the covariance or correlated mutational analysis involves identifying pair-wise positions that are correlated or co-varying based on multiple sequence alignment of related antibody sequences (FIG. 3). For this purpose, the twenty naturally occurring amino acids are classified into various groups based on their physiochemical properties. For example, in the 6 group classification, the twenty amino acids are classified as small hydrophobic, aromatic, neutral polar, positively charged, and negatively charged residues. Glycines and deletions in the sequences are considered as the sixth group. A conservation score is calculated for each pair-wise position using a formula that is similar to that described in Gunasekaran et al., Proteins 54:179-194, 2004 (Gunasekaran et al. 2004). Conservation score is defined as number of pairs belonging to the same physiochemical groups and subtract that sum with number of pairs belonging to different physiochemical groups. For example, in the case of 20 amino acids being classified into three groups, conservation score=No. of HiHj+No. of PiPj−[No. of HiPj+No. of deletion at i with Hj or Pj]. Where, i=1, N−1; j=i+1, N; N=sequence length of the target sequence of interest; H—hydrophobic; P—Polar amino acids. The conservation score could be a positive or negative integral number.

A threshold or cutoff is defined as conservation score×100/total number of sequences. Based on the conservation score, pair-wise positions that are correlated at different threshold levels (60 to 90%) are identified. The second step of the correlated mutational analysis involves identifying deviations (or covariance violations) in the target antibody sequence, i.e., pairs correlated in related antibody sequences (known antibody sequences belong to the same subtype as the target sequence of interest) but not correlated in the target sequence. The third step of the correlated mutational analysis involves fixing the covariance violations. This may be done by examining which amino acids are occurring frequently at the covariance violation position(s) in the database of related antibody sequences. Further, in preferred embodiments, care is taken to make sure that the substituted amino acid is found in the germline or in the related germline sequences and the sequence and structural context is maintained as in the germline sequences. This step is done to reduce the possibility of immunogenicity that may arise due to the mutation.

### Antigen Binding Proteins Improved by a Method of the Invention

Essentially any antigen binding protein comprising an antibody variable domain may be analyzed by the methods described herein and, when violations are found in the sequence of the variable domain, improved through substitution of the violating residues with non-violating residues, e.g., germline or related-germline residues. Preferred antigen binding proteins are therapeutic antibodies. The improved therapeutic antibody may have one or more violations “fixed” in the variable domain of the light chain and/or the variable domain of the heavy chain.

In certain embodiments, the antigen binding protein analyzed and improved by the methods described herein is a therapeutic antibody approved for use, in clinical trials, or in development for clinical use. Such therapeutic antibodies include, but are not limited to, rituximab (Rituxan®, IDEC/Genentech/Roche) (see for example U.S. Pat. No. 5,736,137), a chimeric anti-CD20 antibody approved to treat Non-Hodgkin's lymphoma; HuMax-CD20, an anti-CD20 currently being developed by Genmab, an anti-CD20 antibody described in U.S. Pat. No. 5,500,362, AME-133 (Applied Molecular Evolution), hA20 (Immunomedics, Inc.), HumaLYM (Intracel), and PRO70769 (PCT/US2003/040426, entitled “Immunoglobulin Variants and Uses Thereof”), trastuzumab (Herceptin®, Genentech) (see for example U.S. Pat. No. 5,677,171), a humanized anti-Her2/neu antibody approved to treat breast cancer; pertuzumab (rhuMab-2C4, Omnitarg®), currently being developed by Genentech; an anti-Her2 antibody described in U.S. Pat. No. 4,753,894; cetuximab (Erbitux®, Imclone) (U.S. Pat. No. 4,943,533; PCT WO 96/40210), a chimeric anti-EGFR antibody in clinical trials for a variety of cancers; ABX-EGF (Vectibix®, U.S. Pat. No. 6,235,883), HuMax-EGFr (U.S. Ser. No. 10/172,317), currently being developed by Genmab; 425, EMD55900, EMD62000, and EMD72000 (Merck KGaA) (U.S. Pat. No. 5,558,864; Murthy et al. 1987, Arch Biochem Biophys. 252(2):549-60; Rodeck et al., 1987, J Cell Biochem. 35(4):315-20; Kettleborough et al., 1991, Protein Eng. 4(7):773-83); ICR62 (Institute of Cancer Research) (PCT WO 95/20045; Modjtahedi et al., 1993, J. Cell Biophys. 1993, 22 (1-3):12946; Modjtahedi et al., 1993, Br J. Cancer. 1993, 67(2):247-53; Modjtahedi et al, 1996, Br J Cancer, 73(2):228-35; Modjtahedi et al, 2003, Int J Cancer, 105(2):273-80); TheraCIM hR3 (YM Biosciences, Canada and Centro de Immunologia Molecular, Cuba (U.S. Pat. No. 5,891,996; U.S. Pat. No. 6,506,883; Mateo et al, 1997, Immunotechnology, 3(1):71-81); mAb-806 (Ludwig Institute for Cancer Research, Memorial Sloan-Kettering) (Jungbluth et al. 2003, Proc Natl Acad Sci USA. 100(2):639-44); KSB-102 (KS Biomedix); MR1-1 (IVAX, National Cancer Institute) (PCT WO 0162931A2); and SC100 (Scancell) (PCT WO 01/88138); alemtuzumab (Campath®, Millenium), a humanized monoclonal antibody currently approved for treatment of B-cell chronic lymphocytic leukemia; muromonab-CD3 (Orthoclone OKT3®), an anti-CD3 antibody developed by Ortho Biotech/Johnson & Johnson, ibritumomab tiuxetan (Zevalin®), an anti-CD20 antibody developed by IDEC/Schering AG, gemtuzumab ozogamicin (Mylotarg®), an anti-CD33 (p67 protein) antibody developed by Celltech/Wyeth, alefacept (Amevive®), an anti-LFA-3 Fc fusion developed by Biogen), abciximab (ReoPro®), developed by Centocor/Lilly, basiliximab (Simulect®), developed by Novartis, palivizumab (Synagis®), developed by Medimmune, infliximab (Remicade®), an anti-TNFalpha antibody developed by Centocor, adalimumab (Humira®), an anti-TNFalpha antibody developed by Abbott, Humicade®, an anti-TNFalpha antibody developed by Celltech, golimumab (CNTO-148), a fully human TNF antibody developed by Centocor, ABX-CBL, an anti-CD147 antibody being developed by Abgenix, ABX-IL8, an anti-IL8 antibody being developed by Abgenix, ABX-MA1, an anti-MUC18 antibody being developed by Abgenix, Pemtumomab (R1549, 90Y-muHMFG1), an anti-MUC1 in development by Antisoma, Therex (R1550), an anti-MUC1 antibody being developed by Antisoma, AngioMab (AS1405), being developed by Antisoma, HuBC-1, being developed by Antisoma, Thioplatin (AS1407) being developed by Antisoma, Antegren® (natalizumab), an anti-alpha-4-beta-1 (VLA-4) and alpha-4-beta-7 antibody being developed by Biogen, VLA-1 mAb, an anti-VLA-1 integrin antibody being developed by Biogen, LTBR mAb, an anti-lymphotoxin beta receptor (LTBR) antibody being developed by Biogen, CAT-152, an anti-TGF-.beta.2 antibody being developed by Cambridge Antibody Technology, ABT 874 (J695), an anti-IL-12 p40 antibody being developed by Abbott, CAT-192, an anti-TGF.beta.1 antibody being developed by Cambridge Antibody Technology and Genzyme, CAT-213, an anti-Eotaxin1 antibody being developed by Cambridge Antibody Technology, LymphoStat-B® an anti-Blys antibody being developed by Cambridge Antibody Technology and Human Genome Sciences Inc., TRAIL-R1 mAb, an anti-TRAIL-R1 antibody being developed by Cambridge Antibody Technology and Human Genome Sciences, Inc., Avastin® bevacizumab, rhuMAb-VEGF), an anti-VEGF antibody being developed by Genentech, an anti-HER receptor family antibody being developed by Genentech, Anti-Tissue Factor (ATF), an anti-Tissue Factor antibody being developed by Genentech, Xolair® (Omalizumab), an anti-IgE antibody being developed by Genentech, Raptiva® (Efalizumab), an anti-CD11a antibody being developed by Genentech and Xoma, MLN-02 Antibody (formerly LDP-02), being developed by Genentech and Millenium Pharmaceuticals, HuMax CD4, an anti-CD4 antibody being developed by Genmab, HuMax-IL15, an anti-IL15 antibody being developed by Genmab and Amgen, HuMax-Inflam, being developed by Genmab and Medarex, HuMax-Cancer, an anti-Heparanase I antibody being developed by Genmab and Medarex and Oxford GcoSciences, HuMax-Lymphoma, being developed by Genmab and Amgen, HuMax-TAC, being developed by Genmab, IDEC-131, and anti-CD40L antibody being developed by IDEC Pharmaceuticals, IDEC-151 (Clenoliximab), an anti-CD4 antibody being developed by IDEC Pharmaceuticals, IDEC-114, an anti-CD80 antibody being developed by IDEC Pharmaceuticals, IDEC-152, an anti-CD23 being developed by IDEC Pharmaceuticals, anti-macrophage migration factor (MIF) antibodies being developed by IDEC Pharmaceuticals, BEC2, an anti-idiotypic antibody being developed by Imclone, IMC-1C11, an anti-KDR antibody being developed by Imclone, DC101, an anti-flk-1 antibody being developed by Imclone, anti-VE cadherin antibodies being developed by Imclone, CEA-Cide® (labetuzumab), an anti-carcinoembryonic antigen (CEA) antibody being developed by Immunomedics, LymphoCide® (Epratuzumab), an anti-CD22 antibody being developed by Immunomedics, AFP-Cide, being developed by Immunomedics, MyelomaCide, being developed by Immunomedics, LkoCide, being developed by Immunomedics, ProstaCide, being developed by Immunomedics, MDX-010, an anti-CTLA4 antibody being developed by Medarex, MDX-060, an anti-CD30 antibody being developed by Medarex, MDX-070 being developed by Medarex, MDX-018 being developed by Medarex, Osidem® (IDM-1), and anti-Her2 antibody being developed by Medarex and Immuno-Designed Molecules, HuMax®-CD4, an anti-CD4 antibody being developed by Medarex and Genmab, HuMax-IL15, an anti-IL15 antibody being developed by Medarex and Genmab, CNTO 148, an anti-TNF.alpha. antibody being developed by Medarex and Centocor/J&J, CNTO 1275, an anti-cytokine antibody being developed by Centocor/J&J, MOR101 and MOR102, anti-intercellular adhesion molecule-1 (ICAM-1) (CD54) antibodies being developed by MorphoSys, MOR201, an anti-fibroblast growth factor receptor 3 (FGFR-3) antibody being developed by MorphoSys, Nuvion® (visilizumab), an anti-CD3 antibody being developed by Protein Design Labs, HuZAF®, an anti-gamma interferon antibody being developed by Protein Design Labs, Anti-.alpha. 5.beta.1 Integrin, being developed by Protein Design Labs, anti-IL-12, being developed by Protein Design Labs, ING-1, an anti-Ep-CAM antibody being developed by Xoma, Xolair® (Omalizumab) a humanized anti-IgE antibody developed by Genentech and Novartis, and MLN01, an anti-Beta2 integrin antibody being developed by Xoma, all of the above-cited references in this paragraph are expressly incorporated herein by reference.

Additional antigen binding proteins that may be analyzed and improved by the methods described herein include those described in the following US patents and published patent applications (which are incorporated herein by reference in their entirety: U.S. Pat. Nos. 7,364,736; 7,872,106; 7,871,611; 7,868,140; 7,867,494; 7,842,788; 7,833,527; 7,824,679; 7,807,798; 7,807,795; 7,807,159; 7,736,644; 7,728,113; 7,728,110; 7,718,776; 7,709,611; 7,700,742; 7,658,924; 7,628,986; 7,618,633; 7,601,818; 7,592,430; 7,585,500; 7,579,186; 7,572,444; 7,569,387; 7,566,772; 7,541,438; 7,537,762; 7,524,496; 7,521,053; 7,521,048; 7,498,420; 7,449,555; 7,438,910; 7,435,796; 7,423,128; 7,411,057; 7,378,091; 7,371,381; 7,335,743; 7,288,253; 7,285,269; 7,265,212; 7,135,174; 7,084,257; 7,081,523; 6,169,167; 6,143,874; 4,599,306; 4,504,586; 7,705,130; 7,592,429; 6,849,450; 7,820,877; 7,794,970; 7,563,442; 7,422,742; 7,326,414; 7,288,251; 7,202,343; 7,141,653; 7,090,844; 7,078,492; 7,037,498; 6,924,360; 6,682,736; 6,500,429; 6,235,883; 5,885,574; 7,872,113; 7,807,796; 7,786,271; 7,767,793; 7,763,434; 7,744,886; 7,741,115; 7,704,501; 7,638,606; 7,411,050; 7,304,144; 7,285,643; 7,273,609; 7,199,224; 7,138,500; 7,067,475; 7,057,022; 7,045,128; 6,793,919; 6,740,522; 6,716,587; 6,596,852; 6,562,949; 6,521,228; 6,511,665; 6,232,447; 6,184,359; 6,177,079; 6,150,584; 6,110,690; 6,072,037; 6,015,559; 6,004,553; 5,969,110; 5,961,974; 5,925,740; 5,892,001; 5,785,967; 5,728,813; 5,717,072; 5,677,430; 5,620,889; 5,591,630; 5,543,320; 20110052604; 20110045537; 20110044986; 20110040076; 20110027287; 20110014201; 20110008841; 7,888,482; 7,887,799; 20100292442; 20100255538; 20100254975; 20100247545; 20100209435; 20100197005; 20100183616; 20100111979; 20100098694; 20100047253; 20100040619; 20100036091; 20100034818; 20100028906; 20100028345; 20100015723; 7,795,413; 20090306351; 20090285824; 20090274688; 20090263383; 20090240038; 20090238823; 20090234106; 20090226447; 20090226438; 20090214559; 20090191212; 20090175887; 20090155274; 20090155164; 20090074758; 20090041784; 20080292639; 20080248043; 20080221307; 20080166352; 20080152587; 20080107655; 20080064104; 20080033157; 20070237759; 20070196376; 20070065444; 20070014793; 20060275292; 20060263354; 20060246064; 20060127393; 20060078967; 20060002931; 20050152896; 2050124537; 20050004353; 20050003400; 20040260064; 20040097712; 20030026806; 20010027179; 5,552,286; 5,106,760; 4,845,198; 4,558,006; 20100305307; 7,790,674; 7,695,948; 7,666,839; 20090208489; and 20080132688.

In one embodiment, the improved antigen binding protein is an antibody comprising from one to six CDRs. The antibody may be of any type including IgM, IgG (including IgG1, IgG2, IgG3, IgG4), IgD, IgA, or IgE antibody. In a specific embodiment, the antigen binding protein is an IgG type antibody, e.g., a IgG1 antibody.

In certain embodiments, the improved antigen binding protein is a multispecific antibody, and notably a bispecfic antibody, also sometimes referred to as “diabodies.” These are antibodies that bind to two or more different antigens or different epitopes on a single antigen. In certain embodiments, a bispecific antibody binds to an antigen on a human effector cell (e.g., T cell). Such antibodies are useful in targeting an effector cell response against a target expressing cell, such as a tumor cell. In preferred embodiments, the human effector cell antigen is CD3. U.S. Pat. No. 7,235,641. Methods of making bispecific antibodies are known in the art. One such method involves engineering the Fc portion of the heavy chains such as to create “knobs” and “holes” which facilitate heterodimer formation of the heavy chains when co-expressed in a cell. U.S. Pat. No. 7,695,963. Another method also involves engineering the Fc portion of the heavy chain but uses electrostatic steering to encourage heterodimer formation while discouraging homodimer formation of the heavy chains when co-expressed in a cell. WO 09/089,004, which is incorporated herein by reference in its entirety.

In one embodiment, the improved antigen binding protein is a minibody. Minibodies are minimized antibody-like proteins comprising a scFv joined to a CH3 domain. Hu et al., 1996, Cancer Res. 56:3055-3061.

In one embodiment, the improved antigen binding protein is a domain antibody; see, for example U.S. Pat. No. 6,248,516. Domain antibodies (dAbs) are functional binding domains of antibodies, corresponding to the variable regions of either the heavy (VH) or light (VL) chains of human antibodies. dABs have a molecular weight of approximately 13 kDa, or less than one-tenth the size of a full antibody. dABs are well expressed in a variety of hosts including bacterial, yeast, and mammalian cell systems. In addition, dAbs are highly stable and retain activity even after being subjected to harsh conditions, such as freeze-drying or heat denaturation. See, for example, U.S. Pat. Nos. 6,291,158; 6,582,915; 6,593,081; 6,172,197; US Ser. No. 2004/0110941; European Patent 0368684; U.S. Pat. No. 6,696,245, PCT WO 04/058821, PCT WO 04/003019 and PCT WO 03/002609.

In one embodiment, the improved antigen binding protein is an antibody fragment. In various embodiments, the improved antibody binding proteins comprise, but are not limited to, a F(ab), F(ab′), F(ab′)2, Fv, or a single chain Fv fragments.

Further examples of improved binding antibody fragments include, but are not limited to, those comprising (i) the Fab fragment consisting of VL, VH, CL and CH1 domains, (ii) the Fd fragment consisting of the VH and CH1 domains, (iii) the Fv fragment consisting of the VL and VH domains of a single antibody; (iv) the dAb fragment (Ward et al., 1989, Nature 341:544-546) which consists of a single variable, (v) isolated framework and CDR regions, (vi) F(ab′)₂ fragments, a bivalent fragment comprising two linked Fab fragments (vii) single chain Fv molecules (scFv), wherein a VH domain and a VL domain are linked by a peptide linker which allows the two domains to associate to form an antigen binding site (Bird et al., 1988, Science 242:423-426, Huston et al., 1988, Proc. Natl. Acad. Sci. U.S.A. 85:5879-5883), (viii) bispecific single chain Fv dimers (PCT/US92/09965) and (ix) “diabodies” or “triabodies”, multivalent or multispecific fragments constructed by gene fusion (Tomlinson et. al., 2000, Methods Enzymol. 326:461-479; WO94/13804; Holliger et al., 1993, Proc. Natl. Acad. Sci. U.S.A. 90:6444-6448).

The antibody fragments may be further modified. For example, the molecules may be stabilized by the incorporation of disulphide bridges linking the VH and VL domains (Reiter et al., 1996, Nature Biotech. 14:1239-1245).

In certain embodiments, the improved antigen binding protein is a single chain antibody. Single chain antibodies may be formed by linking heavy and light chain variable domain (Fv region) fragments via an amino acid bridge (short peptide linker), resulting in a single polypeptide chain. Such single-chain Fvs (scFvs) have been prepared by fusing DNA encoding a peptide linker between DNAs encoding the two variable domain polypeptides (V_{L} and V_{H}). The resulting polypeptides can fold back on themselves to form antigen-binding monomers, or they can form multimers (e.g., dimers, trimers, or tetramers), depending on the length of a flexible linker between the two variable domains (Kortt et al., 1997, Prot. Eng. 10:423; Kortt et al., 2001, Biomol. Eng. 18:95-108). By combining different V_{L} and V_{H}-comprising polypeptides, one can form multimeric scFvs that bind to different epitopes (Kriangkum et al., 2001, Biomol. Eng. 18:31-40). Techniques developed for the production of single chain antibodies include those described in U.S. Pat. No. 4,946,778; Bird, 1988, Science 242:423; Huston et al., 1988, Proc. Natl. Acad. Sci. USA 85:5879; Ward et al., 1989, Nature 334:544, de Graaf et al., 2002, Methods Mol Biol. 178:379-87.

In one embodiment, the improved antigen binding protein is an antibody fusion protein (sometimes referred to as an “antibody conjugate”). The conjugate partner can be proteinaceous or non-proteinaceous; the latter generally being generated using functional groups on the antigen binding protein and on the conjugate partner. In certain embodiments, the antibody is conjugated to a non-proteinaceous chemical (drug) to form an antibody drug conjugate.

In some embodiments, the improved antigen binding proteins of the invention are isolated proteins or substantially pure proteins. An “isolated” protein is unaccompanied by at least some of the material with which it is normally associated in its natural state, for example constituting at least about 5%, or at least about 50% by weight of the total protein in a given sample. It is understood that the isolated protein may constitute from 5 to 99.9% by weight of the total protein content depending on the circumstances. For example, the protein may be made at a significantly higher concentration through the use of an inducible promoter or high expression promoter, such that the protein is made at increased concentration levels. The definition includes the production of an antigen binding protein in a wide variety of organisms and/or host cells that are known in the art.

The improved antigen binding proteins may be further modified. Covalent modifications of improved antigen binding proteins are included within the scope of this invention, and are generally, but not always, done post-translationally. For example, several types of covalent modifications of the antigen binding protein are introduced into the molecule by reacting specific amino acid residues of the antigen binding protein with an organic derivatizing agent that is capable of reacting with selected side chains or the N- or C-terminal residues.

Cysteinyl residues most commonly are reacted with α-haloacetates (and corresponding amines), such as chloroacetic acid or chloroacetamide, to give carboxymethyl or carboxyamidomethyl derivatives. Cysteinyl residues also are derivatized by reaction with bromotrifluoroacetone, α-bromo-β-(5-imidozoyl)propionic acid, chloroacetyl phosphate, N-alkylmaleimides, 3-nitro-2-pyridyl disulfide, methyl 2-pyridyl disulfide, p-chloromercuribenzoate, 2-chloromercuri-4-nitrophenol, or chloro-7-nitrobenzo-2-oxa-1,3-diazole.

Histidyl residues are derivatized by reaction with diethylpyrocarbonate at pH 5.5-7.0 because this agent is relatively specific for the histidyl side chain. Para-bromophenacyl bromide also is useful; the reaction is preferably performed in 0.1M sodium cacodylate at pH 6.0.

Lysinyl and amino terminal residues are reacted with succinic or other carboxylic acid anhydrides. Derivatization with these agents has the effect of reversing the charge of the lysinyl residues. Other suitable reagents for derivatizing alpha-amino-containing residues include imidoesters such as methyl picolinimidate; pyridoxal phosphate; pyridoxal; chloroborohydride; trinitrobenzenesulfonic acid; O-methylisourea; 2,4-pentanedione; and transaminase-catalyzed reaction with glyoxylate.

Arginyl residues are modified by reaction with one or several conventional reagents, among them phenylglyoxal, 2,3-butanedione, 1,2-cyclohexanedione, and ninhydrin. Derivatization of arginine residues requires that the reaction be performed in alkaline conditions because of the high pKₐ of the guanidine functional group. Furthermore, these reagents may react with the groups of lysine as well as the arginine epsilon-amino group.

The specific modification of tyrosyl residues may be made, with particular interest in introducing spectral labels into tyrosyl residues by reaction with aromatic diazonium compounds or tetranitromethane. Most commonly, N-acetylimidizole and tetranitromethane are used to form O-acetyl tyrosyl species and 3-nitro derivatives, respectively. Tyrosyl residues are iodinated using ¹²⁵I or ¹³¹I to prepare labeled proteins for use in radioimmunoassay, the chloramine T method described above being suitable.

Carboxyl side groups (aspartyl or glutamyl) are selectively modified by reaction with carbodiimides (R′—N═C═N—R′), where R and R′ are optionally different alkyl groups, such as 1-cyclohexyl-3-(2-morpholinyl-4-ethyl)carbodiimide or 1-ethyl-3-(4-azonia-4,4-dimethylpentyl)carbodiimide. Furthermore, aspartyl and glutamyl residues are converted to asparaginyl and glutaminyl residues by reaction with ammonium ions.

Derivatization with bifunctional agents is useful for crosslinking antigen binding proteins to a water-insoluble support matrix or surface for use in a variety of methods. Commonly used crosslinking agents include, e.g., 1,1-bis(diazoacetyl)-2-phenylethane, glutaraldehyde, N-hydroxysuccinimide esters, for example, esters with 4-azidosalicylic acid, homobifunctional imidoesters, including disuccinimidyl esters such as 3,3′-dithiobis(succinimidylpropionate), and bifunctional maleimides such as bis-N-maleimido-1,8-octane. Derivatizing agents such as methyl-3-[(p-azidophenyl)dithio]propioimidate yield photoactivatable intermediates that are capable of forming crosslinks in the presence of light. Alternatively, reactive water-insoluble matrices such as cyanogen bromide-activated carbohydrates and the reactive substrates described in U.S. Pat. Nos. 3,969,287; 3,691,016; 4,195,128; 4,247,642; 4,229,537; and 4,330,440 are employed for protein immobilization.

Glutaminyl and asparaginyl residues are frequently deamidated to the corresponding glutamyl and aspartyl residues, respectively. Alternatively, these residues are deamidated under mildly acidic conditions. Either form of these residues falls within the scope of this invention.

Other modifications include hydroxylation of proline and lysine, phosphorylation of hydroxyl groups of seryl or threonyl residues, methylation of the α-amino groups of lysine, arginine, and histidine side chains (T. E. Creighton, Proteins: Structure and Molecular Properties, W. H. Freeman & Co., San Francisco, 1983, pp. 79-86), acetylation of the N-terminal amine, and amidation of any C-terminal carboxyl group.

Another type of covalent modification of an improved antigen binding protein included within the scope of this invention comprises altering the glycosylation pattern of the protein. As is known in the art, glycosylation patterns can depend on both the sequence of the protein (e.g., the presence or absence of particular glycosylation amino acid residues, discussed below), or the host cell or organism in which the protein is produced. Particular expression systems are discussed below.

Glycosylation of polypeptides is typically either N-linked or O-linked. N-linked refers to the attachment of the carbohydrate moiety to the side chain of an asparagine residue. The tri-peptide sequences asparagine-X-serine and asparagine-X-threonine, where X is any amino acid except proline, are the recognition sequences for enzymatic attachment of the carbohydrate moiety to the asparagine side chain. Thus, the presence of either of these tri-peptide sequences in a polypeptide creates a potential glycosylation site. O-linked glycosylation refers to the attachment of one of the sugars N-acetylgalactosamine, galactose, or xylose, to a hydroxyamino acid, most commonly serine or threonine, although 5-hydroxyproline or 5-hydroxylysine may also be used.

Addition of glycosylation sites to the improved antigen binding protein is conveniently accomplished by altering the amino acid sequence such that it contains one or more of the above-described tri-peptide sequences (for N-linked glycosylation sites). The alteration may also be made by the addition of, or substitution by, one or more serine or threonine residues to the starting sequence (for O-linked glycosylation sites). For ease, the antigen binding protein amino acid sequence is preferably altered through changes at the DNA level, particularly by mutating the DNA encoding the target polypeptide at preselected bases such that codons are generated that will translate into the desired amino acids.

Another means of increasing the number of carbohydrate moieties on the improved antigen binding protein is by chemical or enzymatic coupling of glycosides to the protein. These procedures are advantageous in that they do not require production of the protein in a host cell that has glycosylation capabilities for N- and O-linked glycosylation. Depending on the coupling mode used, the sugar(s) may be attached to (a) arginine and histidine, (b) free carboxyl groups, (c) free sulfhydryl groups such as those of cysteine, (d) free hydroxyl groups such as those of serine, threonine, or hydroxyproline, (e) aromatic residues such as those of phenylalanine, tyrosine, or tryptophan, or (f) the amide group of glutamine. These methods are described in WO 87/05330 published Sep. 11, 1987, and in Aplin and Wriston, 1981, CRC Crit. Rev. Biochem., pp. 259-306.

Removal of carbohydrate moieties present on the improved antigen binding protein may be accomplished chemically or enzymatically. Chemical deglycosylation requires exposure of the protein to the compound trifluoromethanesulfonic acid, or an equivalent compound. This treatment results in the cleavage of most or all sugars except the linking sugar (N-acetylglucosamine or N-acetylgalactosamine), while leaving the polypeptide intact. Chemical deglycosylation is described by Hakimuddin et al., 1987, Arch. Biochem. Biophys. 259:52 and by Edge et al., 1981, Anal. Biochem. 118:131. Enzymatic cleavage of carbohydrate moieties on polypeptides can be achieved by the use of a variety of endo- and exo-glycosidases as described by Thotakura et al., 1987, Meth. Enzymol. 138:350. Glycosylation at potential glycosylation sites may be prevented by the use of the compound tunicamycin as described by Duskin et al., 1982, J. Biol. Chem. 257:3105. Tunicamycin blocks the formation of protein-N-glycoside linkages.

Another type of covalent modification of the improved antigen binding protein comprises linking the antigen binding protein to various nonproteinaceous polymers, including, but not limited to, various polyols such as polyethylene glycol, polypropylene glycol or polyoxyalkylenes, in the manner set forth in U.S. Pat. No. 4,640,835; 4,496,689; 4,301,144; 4,670,417; 4,791,192 or 4,179,337. In addition, as is known in the art, amino acid substitutions may be made in various positions within the antigen binding protein to facilitate the addition of polymers such as PEG.

In some embodiments, the covalent modification of the improved antigen binding proteins of the invention comprises the addition of one or more labels.

The term “labelling group” means any detectable label. Examples of suitable labelling groups include, but are not limited to, the following: radioisotopes or radionuclides (e.g., ³H, ¹⁴C, ¹⁵N, ³⁵S, ⁹⁰Y, ⁹⁹Tc, ¹¹¹In, ¹²⁵I, ¹³¹I), fluorescent groups (e.g., FITC, rhodamine, lanthanide phosphors), enzymatic groups (e.g., horseradish peroxidase, β-galactosidase, luciferase, alkaline phosphatase), chemiluminescent groups, biotinyl groups, or predetermined polypeptide epitopes recognized by a secondary reporter (e.g., leucine zipper pair sequences, binding sites for secondary antibodies, metal binding domains, epitope tags). In some embodiments, the labelling group is coupled to the improved antigen binding protein via spacer arms of various lengths to reduce potential steric hindrance. Various methods for labelling proteins are known in the art and may be used in performing the present invention.

Specific labels include optical dyes, including, but not limited to, chromophores, phosphors and fluorophores, with the latter being specific in many instances. Fluorophores can be either “small molecule” fluores, or proteinaceous fluores.

By “fluorescent label” is meant any molecule that may be detected via its inherent fluorescent properties. Suitable fluorescent labels include, but are not limited to, fluorescein, rhodamine, tetramethylrhodamine, eosin, erythrosin, coumarin, methyl-coumarins, pyrene, Malacite green, stilbene, Lucifer Yellow, Cascade BlueJ, Texas Red, IAEDANS, EDANS, BODIPY FL, LC Red 640, Cy 5, Cy 5.5, LC Red 705, Oregon green, the Alexa-Fluor dyes (Alexa Fluor 350, Alexa Fluor 430, Alexa Fluor 488, Alexa Fluor 546, Alexa Fluor 568, Alexa Fluor 594, Alexa Fluor 633, Alexa Fluor 660, Alexa Fluor 680), Cascade Blue, Cascade Yellow and R-phycoerythrin (PE) (Molecular Probes, Eugene, Oreg.), FITC, Rhodamine, and Texas Red (Pierce, Rockford, Ill.), Cy5, Cy5.5, Cy7 (Amersham Life Science, Pittsburgh, Pa.). Suitable optical dyes, including fluorophores, are described in Molecular Probes Handbook by Richard P. Haugland, hereby expressly incorporated by reference.

Suitable proteinaceous fluorescent labels also include, but are not limited to, green fluorescent protein, including a Renilla, Ptilosarcus, or Aequorea species of GFP (Chalfie et al., 1994, Science 263:802-805), EGFP (Clontech Laboratories, Inc., Genbank Accession Number U55762), blue fluorescent protein (BFP, Quantum Biotechnologies, Inc. 1801 de Maisonneuve Blvd. West, 8th Floor, Montreal, Quebec, Canada H3H 1J9; Stauber, 1998, Biotechniques 24:462-471; Heim et al., 1996, Curr. Biol. 6:178-182), enhanced yellow fluorescent protein (EYFP, Clontech Laboratories, Inc.), luciferase (Ichiki et al., 1993, J. Immunol. 150:5408-5417), β galactosidase (Nolan et al., 1988, Proc. Natl. Acad. Sci. U.S.A. 85:2603-2607) and Renilla (WO92/15673, WO95/07463, WO98/14605, WO98/26277, WO99/49019, U.S. Pat. Nos. 5,292,658, 5,418,155, 5,683,888, 5,741,668, 5,777,079, 5,804,387, 5,874,304, 5,876,995, 5,925,558). All of the above-cited references are expressly incorporated herein by reference.

### Isolated Nucleic Acids

The methods described herein include steps wherein the amino acid sequence of an antigen binding protein is altered. Alteration of the amino acid sequence is best accomplished by changing one or more codons within the nucleic acid sequence encoding the antigen binding protein or portion thereof. Thus, in certain aspects, the invention relates to isolated nucleic acids encoding an improved antigen binding protein or improved portion thereof, e.g., light chain variable domain or heavy chain variable domain.

In preferred embodiments, the codon that replaces the existing codon is a codon that is preferentially used in the cell which is chosen to express the antigen binding protein. For example, if the antigen binding protein is to be expressed in E. coli, care should be given to use a codon for a given amino acid that is preferentially used in E. coli.

Nucleic acid molecules of the invention include DNA and RNA in both single-stranded and double-stranded form, as well as the corresponding complementary sequences. DNA includes, for example, cDNA, genomic DNA, chemically synthesized DNA, DNA amplified by PCR, and combinations thereof. The nucleic acid molecules of the invention include full-length genes or cDNA molecules as well as a combination of fragments thereof. The nucleic acids of the invention are preferentially derived from human sources, but the invention includes those derived from non-human species, as well.

An “isolated nucleic acid” is a nucleic acid that has been separated from adjacent genetic sequences present in the genome of the organism from which the nucleic acid was isolated, in the case of nucleic acids isolated from naturally-occurring sources. In the case of nucleic acids synthesized enzymatically from a template or chemically, such as PCR products, cDNA molecules, or oligonucleotides for example, it is understood that the nucleic acids resulting from such processes are isolated nucleic acids. An isolated nucleic acid molecule refers to a nucleic acid molecule in the form of a separate fragment or as a component of a larger nucleic acid construct. In one preferred embodiment, the nucleic acids are substantially free from contaminating endogenous material. The nucleic acid molecule has preferably been derived from DNA or RNA isolated at least once in substantially pure form and in a quantity or concentration enabling identification, manipulation, and recovery of its component nucleotide sequences by standard biochemical methods (such as those outlined in Sambrook et al., Molecular Cloning: A Laboratory Manual, 2nd ed., Cold Spring Harbor Laboratory, Cold Spring Harbor, N.Y. (1989)). Such sequences are preferably provided and/or constructed in the form of an open reading frame uninterrupted by internal non-translated sequences, or introns, that are typically present in eukaryotic genes. Sequences of non-translated DNA can be present 5′ or 3′ from an open reading frame, where the same do not interfere with manipulation or expression of the coding region.

The improved amino acid sequences of the invention are ordinarily prepared by site specific mutagenesis of nucleotides in the DNA encoding the antigen binding protein, using cassette or PCR mutagenesis or other techniques well known in the art, to produce DNA encoding the variant, and thereafter expressing the recombinant DNA in cell culture as outlined herein.

As will be appreciated by those in the art, due to the degeneracy of the genetic code, an extremely large number of nucleic acids may be made, all of which encode the improved antigen binding protein. Thus, having identified a particular amino acid sequence, those skilled in the art could make any number of different nucleic acids, by simply modifying the sequence of one or more codons in a way which does not change the amino acid sequence of the encoded protein.

The present invention also provides expression systems and constructs in the form of plasmids, expression vectors, transcription or expression cassettes which comprise at least one polynucleotide as above. In addition, the invention provides host cells comprising such expression systems or constructs.

Typically, expression vectors used in any of the host cells will contain sequences for plasmid maintenance and for cloning and expression of exogenous nucleotide sequences. Such sequences, collectively referred to as “flanking sequences” in certain embodiments will typically include one or more of the following nucleotide sequences: a promoter, one or more enhancer sequences, an origin of replication, a transcriptional termination sequence, a complete intron sequence containing a donor and acceptor splice site, a sequence encoding a leader sequence for polypeptide secretion, a ribosome binding site, a polyadenylation sequence, a polylinker region for inserting the nucleic acid encoding the polypeptide to be expressed, and a selectable marker element. Each of these sequences is discussed below.

Optionally, the vector may contain a “tag”-encoding sequence, i.e., an oligonucleotide molecule located at the 5′ or 3′ end of the improved antigen binding protein coding sequence; the oligonucleotide sequence encodes polyHis (such as hexaHis), or another “tag” such as FLAG, HA (hemaglutinin influenza virus), or myc, for which commercially available antibodies exist. This tag is typically fused to the polypeptide upon expression of the polypeptide, and can serve as a means for affinity purification or detection of the improved antigen binding protein from the host cell. Affinity purification can be accomplished, for example, by column chromatography using antibodies against the tag as an affinity matrix. Optionally, the tag can subsequently be removed from the purified improved antigen binding protein by various means such as using certain peptidases for cleavage.

Flanking sequences may be homologous (i.e., from the same species and/or strain as the host cell), heterologous (i.e., from a species other than the host cell species or strain), hybrid (i.e., a combination of flanking sequences from more than one source), synthetic or native. As such, the source of a flanking sequence may be any prokaryotic or eukaryotic organism, any vertebrate or invertebrate organism, or any plant, provided that the flanking sequence is functional in, and can be activated by, the host cell machinery.

Flanking sequences useful in the vectors of this invention may be obtained by any of several methods well known in the art. Typically, flanking sequences useful herein will have been previously identified by mapping and/or by restriction endonuclease digestion and can thus be isolated from the proper tissue source using the appropriate restriction endonucleases. In some cases, the full nucleotide sequence of a flanking sequence may be known. Here, the flanking sequence may be synthesized using the methods described herein for nucleic acid synthesis or cloning.

Whether all or only a portion of the flanking sequence is known, it may be obtained using polymerase chain reaction (PCR) and/or by screening a genomic library with a suitable probe such as an oligonucleotide and/or flanking sequence fragment from the same or another species. Where the flanking sequence is not known, a fragment of DNA containing a flanking sequence may be isolated from a larger piece of DNA that may contain, for example, a coding sequence or even another gene or genes. Isolation may be accomplished by restriction endonuclease digestion to produce the proper DNA fragment followed by isolation using agarose gel purification, Qiagen® column chromatography (Chatsworth, Calif.), or other methods known to the skilled artisan. The selection of suitable enzymes to accomplish this purpose will be readily apparent to one of ordinary skill in the art.

An origin of replication is typically a part of those prokaryotic expression vectors purchased commercially, and the origin aids in the amplification of the vector in a host cell. If the vector of choice does not contain an origin of replication site, one may be chemically synthesized based on a known sequence, and ligated into the vector. For example, the origin of replication from the plasmid pBR322 (New England Biolabs, Beverly, Mass.) is suitable for most gram-negative bacteria, and various viral origins (e.g., SV40, polyoma, adenovirus, vesicular stomatitus virus (VSV), or papillomaviruses such as HPV or BPV) are useful for cloning vectors in mammalian cells. Generally, the origin of replication component is not needed for mammalian expression vectors (for example, the SV40 origin is often used only because it also contains the virus early promoter).

A transcription termination sequence is typically located 3′ to the end of a polypeptide coding region and serves to terminate transcription. Usually, a transcription termination sequence in prokaryotic cells is a G-C rich fragment followed by a poly-T sequence. While the sequence is easily cloned from a library or even purchased commercially as part of a vector, it can also be readily synthesized using methods for nucleic acid synthesis such as those described herein.

A selectable marker gene encodes a protein necessary for the survival and growth of a host cell grown in a selective culture medium. Typical selection marker genes encode proteins that (a) confer resistance to antibiotics or other toxins, e.g., ampicillin, tetracycline, or kanamycin for prokaryotic host cells; (b) complement auxotrophic deficiencies of the cell; or (c) supply critical nutrients not available from complex or defined media. Specific selectable markers are the kanamycin resistance gene, the ampicillin resistance gene, and the tetracycline resistance gene. Advantageously, a neomycin resistance gene may also be used for selection in both prokaryotic and eukaryotic host cells.

Other selectable genes may be used to amplify the gene that will be expressed. Amplification is the process wherein genes that are required for production of a protein critical for growth or cell survival are reiterated in tandem within the chromosomes of successive generations of recombinant cells. Examples of suitable selectable markers for mammalian cells include dihydrofolate reductase (DHFR) and promoterless thyrnidine kinase genes. Mammalian cell transformants are placed under selection pressure wherein only the transformants are uniquely adapted to survive by virtue of the selectable gene present in the vector. Selection pressure is imposed by culturing the transformed cells under conditions in which the concentration of selection agent in the medium is successively increased, thereby leading to the amplification of both the selectable gene and the DNA that encodes another gene, such as an improved antigen binding protein. As a result, increased quantities of a polypeptide such as an improved antigen binding protein are synthesized from the amplified DNA.

A ribosome-binding site is usually necessary for translation initiation of rnRNA and is characterized by a Shine-Dalgarno sequence (prokaryotes) or a Kozak sequence (eukaryotes). The element is typically located 3′ to the promoter and 5′ to the coding sequence of the polypeptide to be expressed. In certain embodiments, one or more coding regions may be operably linked to an internal ribosome binding site (IRES), allowing translation of two open reading frames from a single RNA transcript.

In some cases, such as where glycosylation is desired in a eukaryotic host cell expression system, one may manipulate the various pre- or prosequences to improve glycosylation or yield. For example, one may alter the peptidase cleavage site of a particular signal peptide, or add prosequences, which also may affect glycosylation. The final protein product may have, in the −1 position (relative to the first amino acid of the mature protein) one or more additional amino acids incident to expression, which may not have been totally removed. For example, the final protein product may have one or two amino acid residues found in the peptidase cleavage site, attached to the amino-terminus. Alternatively, use of some enzyme cleavage sites may result in a slightly truncated form of the desired polypeptide, if the enzyme cuts at such area within the mature polypeptide.

Expression and cloning vectors of the invention will typically contain a promoter that is recognized by the host organism and operably linked to the molecule encoding the improved antigen binding protein. Promoters are untranscribed sequences located upstream (i.e., 5′) to the start codon of a structural gene (generally within about 100 to 1000 bp) that control transcription of the structural gene. Promoters are conventionally grouped into one of two classes: inducible promoters and constitutive promoters. Inducible promoters initiate increased levels of transcription from DNA under their control in response to some change in culture conditions, such as the presence or absence of a nutrient or a change in temperature. Constitutive promoters, on the other hand, uniformly transcribe gene to which they are operably linked, that is, with little or no control over gene expression. A large number of promoters, recognized by a variety of potential host cells, are well known. A suitable promoter is operably linked to the DNA encoding heavy chain or light chain comprising an improved antigen binding protein of the invention by removing the promoter from the source DNA by restriction enzyme digestion and inserting the desired promoter sequence into the vector.

Suitable promoters for use with yeast hosts are also well known in the art. Yeast enhancers are advantageously used with yeast promoters. Suitable promoters for use with mammalian host cells are well known and include, but are not limited to, those obtained from the genomes of viruses such as polyoma virus, fowlpox virus, adenovirus (such as Adenovirus 2), bovine papilloma virus, avian sarcoma virus, cytomegalovirus, retroviruses, hepatitis-B virus and most preferably Simian Virus 40 (SV40). Other suitable mammalian promoters include heterologous mammalian promoters, for example, heat-shock promoters and the actin promoter.

Additional promoters which may be of interest include, but are not limited to: SV40 early promoter (Benoist and Chambon, 1981, Nature 290:304-310); CMV promoter (Thomsen et al., 1984, Proc. Natl. Acad. U.S.A. 81:659-663); the promoter contained in the 3′ long terminal repeat of Rous sarcoma virus (Yamamoto et al., 1980, Cell 22:787-797); herpes thymidine kinase promoter (Wagner et al., 1981, Proc. Natl. Acad. Sci. U.S.A. 78:1444-1445); promoter and regulatory sequences from the metallothionine gene Prinster et al., 1982, Nature 296:39-42); and prokaryotic promoters such as the beta-lactamase promoter (Villa-Kamaroff et al., 1978, Proc. Natl. Acad. Sci. U.S.A. 75:3727-3731); or the tac promoter (DeBoer et al., 1983, Proc. Natl. Acad. Sci. U.S.A. 80:21-25). Also of interest are the following animal transcriptional control regions, which exhibit tissue specificity and have been utilized in transgenic animals: the elastase I gene control region that is active in pancreatic acinar cells (Swift et al., 1984, Cell 38:639-646; Ornitz et al., 1986, Cold Spring Harbor Symp. Quant. Biol. 50:399-409; MacDonald, 1987, Hepatology 7:425-515); the insulin gene control region that is active in pancreatic beta cells (Hanahan, 1985, Nature 315:115-122); the immunoglobulin gene control region that is active in lymphoid cells (Grosschedl et al., 1984, Cell 38:647-658; Adames et al., 1985, Nature 318:533-538; Alexander et al., 1987, Mol. Cell. Biol. 7:1436-1444); the mouse mammary tumor virus control region that is active in testicular, breast, lymphoid and mast cells (Leder et al., 1986, Cell 45:485-495); the albumin gene control region that is active in liver (Pinkert et al., 1987, Genes and Devel. 1:268-276); the alpha-feto-protein gene control region that is active in liver (Krumlauf et al., 1985, Mol. Cell. Biol. 5:1639-1648; Hammer et al., 1987, Science 253:53-58); the alpha 1-antitrypsin gene control region that is active in liver (Kelsey et al., 1987, Genes and Devel. 1:161-171); the beta-globin gene control region that is active in myeloid cells (Mogram et al., 1985, Nature 315:338-340; Kollias et al., 1986, Cell 46:89-94); the myelin basic protein gene control region that is active in oligodendrocyte cells in the brain (Readhead et al., 1987, Cell 48:703-712); the myosin light chain-2 gene control region that is active in skeletal muscle (Sani, 1985, Nature 314:283-286); and the gonadotropic releasing hormone gene control region that is active in the hypothalamus (Mason et al., 1986, Science 234:1372-1378).

An enhancer sequence may be inserted into the vector to increase transcription of DNA encoding light chain or heavy chain of an improved antigen binding protein of the invention by higher eukaryotes. Enhancers are cis-acting elements of DNA, usually about 10-300 bp in length, that act on the promoter to increase transcription. Enhancers are relatively orientation and position independent, having been found at positions both 5′ and 3′ to the transcription unit. Several enhancer sequences available from mammalian genes are known (e.g., globin, elastase, albumin, alpha-feto-protein and insulin). Typically, however, an enhancer from a virus is used. The SV40 enhancer, the cytomegalovirus early promoter enhancer, the polyoma enhancer, and adenovirus enhancers known in the art are exemplary enhancing elements for the activation of eukaryotic promoters. While an enhancer may be positioned in the vector either 5′ or 3′ to a coding sequence, it is typically located at a site 5′ from the promoter. A sequence encoding an appropriate native or heterologous signal sequence (leader sequence or signal peptide) can be incorporated into an expression vector, to promote extracellular secretion of the antibody. The choice of signal peptide or leader depends on the type of host cells in which the antibody is to be produced, and a heterologous signal sequence can replace the native signal sequence. Examples of signal peptides that are functional in mammalian host cells include the following: the signal sequence for interleukin-7 (IL-7) described in U.S. Pat. No. 4,965,195; the signal sequence for interleukin-2 receptor described in Cosman et al., 1984, Nature 312:768; the interleukin-4 receptor signal peptide described in EP Patent No. 0367 566; the type I interleukin-1 receptor signal peptide described in U.S. Pat. No. 4,968,607; the type II interleukin-1 receptor signal peptide described in EP Patent No. 0 460 846.

The vector may contain one or more elements that facilitate expression when the vector is integrated into the host cell genome. Examples include an EASE element (Aldrich et al. 2003 Biotechnol Frog. 19:1433-38) and a matrix attachment region (MAR). MARs mediate structural organization of the chromatin and may insulate the integrated vector from “position” effect. Thus, MARs are particularly useful when the vector is used to create stable transfectants. A number of natural and synthetic MAR-containing nucleic acids are known in the art, e.g., U.S. Pat. Nos. 6,239,328; 7,326,567; 6,177,612; 6,388,066; 6,245,974; 7,259,010; 6,037,525; 7,422,874; 7,129,062.

Expression vectors of the invention may be constructed from a starting vector such as a commercially available vector. Such vectors may or may not contain all of the desired flanking sequences. Where one or more of the flanking sequences described herein are not already present in the vector, they may be individually obtained and ligated into the vector. Methods used for obtaining each of the flanking sequences are well known to one skilled in the art.

After the vector has been constructed and a nucleic acid molecule encoding an improved antigen binding protein, or component thereof e.g., light chain, a heavy chain, or a light chain and a heavy chain comprising an improved antigen binding sequence has been inserted into the proper site of the vector, the completed vector may be inserted into a suitable host cell for amplification and/or polypeptide expression. The transformation of an expression vector for an improved antigen binding protein into a selected host cell may be accomplished by well known methods including transfection, infection, calcium phosphate co-precipitation, electroporation, microinjection, lipofection, DEAE-dextran mediated transfection, or other known techniques. The method selected will in part be a function of the type of host cell to be used. These methods and other suitable methods are well known to the skilled artisan, and are set forth, for example, in Sambrook et al., 2001, supra.

A host cell, when cultured under appropriate conditions, synthesizes an improved antigen binding protein that can subsequently be collected from the culture medium (if the host cell secretes it into the medium) or directly from the host cell producing it (if it is not secreted). The selection of an appropriate host cell will depend upon various factors, such as desired expression levels, polypeptide modifications that are desirable or necessary for activity (such as glycosylation or phosphorylation) and ease of folding into a biologically active molecule. A host cell may be eukaryotic or prokaryotic.

Mammalian cell lines available as hosts for expression are well known in the art and include, but are not limited to, immortalized cell lines available from the American Type Culture Collection (ATCC) and any cell lines used in an expression system known in the art can be used to make the recombinant polypeptides of the invention. In general, host cells are transformed with one or more recombinant expression vectors that comprises DNA encoding an improved antigen binding protein. Among the host cells that may be employed are prokaryotes, yeast or higher eukaryotic cells. Prokaryotes include gram negative or gram positive organisms, for example E. coli or bacilli. Higher eukaryotic cells include insect cells and established cell lines of mammalian origin. Examples of suitable mammalian host cell lines include the COS-7 line of monkey kidney cells (ATCC CRL 1651) (Gluzman et al., 1981, Cell 23:175), L cells, 293 cells, C127 cells, 3T3 cells (ATCC CCL 163), Chinese hamster ovary (CHO) cells, or their derivatives such as Veggie CHO and related cell lines which grow in serum-free media (Rasmussen et al., 1998, Cytotechnology 28: 31), HeLa cells, BHK (ATCC CRL 10) cell lines, and the CV1/EBNA cell line derived from the African green monkey kidney cell line CV1 (ATCC CCL 70) as described by McMahan et al., 1991, EMBO J. 10: 2821, human embryonic kidney cells such as 293, 293 EBNA or MSR 293, human epidermal A431 cells, human Colo205 cells, other transformed primate cell lines, normal diploid cells, cell strains derived from in vitro culture of primary tissue, primary explants, HL-60, U937, HaK or Jurkat cells. Optionally, mammalian cell lines such as HepG2/3B, KB, NIH 3T3 or S49, for example, can be used for expression of the polypeptide when it is desirable to use the polypeptide in various signal transduction or reporter assays. Alternatively, it is possible to produce the polypeptide in lower eukaryotes such as yeast or in prokaryotes such as bacteria. Suitable yeasts include Saccharomyces cerevisiae, Schizosaccharomyces pombe, Kluyveromyces strains, Candida, or any yeast strain capable of expressing heterologous polypeptides. Suitable bacterial strains include Escherichia coli, Bacillus subtilis, Salmonella typhimurium, or any bacterial strain capable of expressing heterologous polypeptides. If the polypeptide is made in yeast or bacteria, it may be desirable to modify the polypeptide produced therein, for example by phosphorylation or glycosylation of the appropriate sites, in order to obtain the functional polypeptide. Such covalent attachments can be accomplished using known chemical or enzymatic methods. The polypeptide can also be produced by operably linking the isolated nucleic acid of the invention to suitable control sequences in one or more insect expression vectors, and employing an insect expression system. Materials and methods for baculovirus/insect cell expression systems are commercially available in kit form from, e.g., Invitrogen, San Diego, Calif., U.S.A. (the MaxBac® kit), and such methods are well known in the art, as described in Summers and Smith, Texas Agricultural Experiment Station Bulletin No. 1555 (1987), and Luckow and Summers, Bio/Technology 6:47 (1988). Cell-free translation systems could also be employed to produce polypeptides using RNAs derived from nucleic acid constructs disclosed herein. Appropriate cloning and expression vectors for use with bacterial, fungal, yeast, and mammalian cellular hosts are described by Pouwels et al. (Cloning Vectors: A Laboratory Manual, Elsevier, New York, 1985). A host cell that comprises an isolated nucleic acid of the invention, preferably operably linked to at least one expression control sequence, is a “recombinant host cell”.

### Pharmaceutical Compositions

In some embodiments, the invention provides a pharmaceutical composition comprising a therapeutically effective amount of one or a plurality of improved antigen binding proteins of the invention together with a pharmaceutically effective diluents, carrier, solubilizer, emulsifier, preservative, and/or adjuvant. In certain embodiments, the improved antigen binding protein is an antibody, including a drug-conjugated antibody or a bispecific antibody. Pharmaceutical compositions of the invention include, but are not limited to, liquid, frozen, and lyophilized compositions.

Preferably, formulation materials are nontoxic to recipients at the dosages and concentrations employed. In specific embodiments, pharmaceutical compositions comprising a therapeutically effective amount of an improved antigen binding protein are provided.

In certain embodiments, the pharmaceutical composition may contain formulation materials for modifying, maintaining or preserving, for example, the pH, osmolarity, viscosity, clarity, color, isotonicity, odor, sterility, stability, rate of dissolution or release, adsorption or penetration of the composition. In such embodiments, suitable formulation materials include, but are not limited to, amino acids (such as glycine, glutamine, asparagine, arginine, proline, or lysine); antimicrobials; antioxidants (such as ascorbic acid, sodium sulfite or sodium hydrogen-sulfite); buffers (such as borate, bicarbonate, Tris-HCl, citrates, phosphates or other organic acids); bulking agents (such as mannitol or glycine); chelating agents (such as ethylenediamine tetraacetic acid (EDTA)); complexing agents (such as caffeine, polyvinylpyrrolidone, beta-cyclodextrin or hydroxypropyl-beta-cyclodextrin); fillers; monosaccharides; disaccharides; and other carbohydrates (such as glucose, mannose or dextrins); proteins (such as serum albumin, gelatin or immunoglobulins); coloring, flavoring and diluting agents; emulsifying agents; hydrophilic polymers (such as polyvinylpyrrolidone); low molecular weight polypeptides; salt-forming counterions (such as sodium); preservatives (such as benzalkonium chloride, benzoic acid, salicylic acid, thimerosal, phenethyl alcohol, methylparaben, propylparaben, chlorhexidine, sorbic acid or hydrogen peroxide); solvents (such as glycerin, propylene glycol or polyethylene glycol); sugar alcohols (such as mannitol or sorbitol); suspending agents; surfactants or wetting agents (such as pluronics, PEG, sorbitan esters, polysorbates such as polysorbate 20, polysorbate, triton, tromethamine, lecithin, cholesterol, tyloxapal); stability enhancing agents (such as sucrose or sorbitol); tonicity enhancing agents (such as alkali metal halides, preferably sodium or potassium chloride, mannitol sorbitol); delivery vehicles; diluents; excipients and/or pharmaceutical adjuvants. See, REMINGTON'S PHARMACEUTICAL SCIENCES, 18″ Edition, (A. R. Genrmo, ed.), 1990, Mack Publishing Company.

In certain embodiments, the optimal pharmaceutical composition will be determined by one skilled in the art depending upon, for example, the intended route of administration, delivery format and desired dosage. See, for example, REMINGTON'S PHARMACEUTICAL SCIENCES, supra. In certain embodiments, such compositions may influence the physical state, stability, rate of in vivo release and rate of in vivo clearance of the improved antigen binding proteins of the invention. In certain embodiments, the primary vehicle or carrier in a pharmaceutical composition may be either aqueous or non-aqueous in nature. For example, a suitable vehicle or carrier may be water for injection, physiological saline solution or artificial cerebrospinal fluid, possibly supplemented with other materials common in compositions for parenteral administration. Neutral buffered saline or saline mixed with serum albumin are further exemplary vehicles. In specific embodiments, pharmaceutical compositions comprise Tris buffer of about pH 7.0-8.5, or acetate buffer of about pH 4.0-5.5, and may further include sorbitol or a suitable substitute therefor. In certain embodiments of the invention, improved antigen binding protein compositions may be prepared for storage by mixing the selected composition having the desired degree of purity with optional formulation agents (REMINGTON'S PHARMACEUTICAL SCIENCES, supra) in the form of a lyophilized cake or an aqueous solution. Further, in certain embodiments, the improved antigen binding protein product may be formulated as a lyophilizate using appropriate excipients such as sucrose.

The pharmaceutical compositions of the invention can be selected for parenteral delivery. Alternatively, the compositions may be selected for inhalation or for delivery through the digestive tract, such as orally. Preparation of such pharmaceutically acceptable compositions is within the skill of the art. The formulation components are present preferably in concentrations that are acceptable to the site of administration. In certain embodiments, buffers are used to maintain the composition at physiological pH or at a slightly lower pH, typically within a pH range of from about 5 to about 8.

When parenteral administration is contemplated, the therapeutic compositions may be provided in the form of a pyrogen-free, parenterally acceptable aqueous solution comprising the desired improved antigen binding protein in a pharmaceutically acceptable vehicle. A particularly suitable vehicle for parenteral injection is sterile distilled water in which the improved antigen binding protein is formulated as a sterile, isotonic solution, properly preserved. In certain embodiments, the preparation can involve the formulation of the desired molecule with an agent, such as injectable microspheres, bio-erodible particles, polymeric compounds (such as polylactic acid or polyglycolic acid), beads or liposomes, that may provide controlled or sustained release of the product which can be delivered via depot injection. In certain embodiments, hyaluronic acid may also be used, having the effect of promoting sustained duration in the circulation. In certain embodiments, implantable drug delivery devices may be used to introduce the desired antigen binding protein.

Pharmaceutical compositions can be formulated for inhalation. In these embodiments, improved antigen binding proteins are advantageously formulated as a dry, inhalable powder. In specific embodiments, the improved antigen binding protein inhalation solutions may also be formulated with a propellant for aerosol delivery. In certain embodiments, solutions may be nebulized. Pulmonary administration and formulation methods therefore are further described in International Patent Application No. PCT/US94/001875, which is incorporated by reference and describes pulmonary delivery of chemically modified proteins.

It is also contemplated that formulations can be administered orally. Improved antigen binding proteins that are administered in this fashion can be formulated with or without carriers customarily used in the compounding of solid dosage forms such as tablets and capsules. In certain embodiments, a capsule may be designed to release the active portion of the formulation at the point in the gastrointestinal tract when bioavailability is maximized and pre-systemic degradation is minimized. Additional agents can be included to facilitate absorption of the improved antigen binding protein. Diluents, flavorings, low melting point waxes, vegetable oils, lubricants, suspending agents, tablet disintegrating agents, and binders may also be employed.

Additional pharmaceutical compositions will be evident to those skilled in the art, including formulations involving improved antigen binding proteins in sustained- or controlled-delivery formulations. Techniques for formulating a variety of other sustained- or controlled-delivery means, such as liposome carriers, bio-erodible microparticles or porous beads and depot injections, are also known to those skilled in the art. See, for example, International Patent Application No. PCT/US93/00829, which is incorporated by reference and describes controlled release of porous polymeric microparticles for delivery of pharmaceutical compositions. Sustained-release preparations may include semipermeable polymer matrices in the form of shaped articles, e.g., films, or microcapsules. Sustained release matrices may include polyesters, hydrogels, polylactides (as disclosed in U.S. Pat. No. 3,773,919 and European Patent Application Publication No. EP 058481, each of which is incorporated by reference), copolymers of L-glutamic acid and gamma ethyl-L-glutamate (Sidman et al., 1983, Biopolymers 2:547-556), poly(2-hydroxyethyl-methacrylate) (Langer et al., 1981, J. Biomed. Mater. Res. 15:167-277 and Langer, 1982, Chem. Tech. 12:98-105), ethylene vinyl acetate (Langer et al., 1981, supra) or poly-D(−)-3-hydroxybutyric acid (European Patent Application Publication No. EP 133,988). Sustained release compositions may also include liposomes that can be prepared by any of several methods known in the art. See, e.g., Eppstein et al., 1985, Proc. Natl. Acad. Sci. U.S.A. 82:3688-3692; European Patent Application Publication Nos. EP 036,676; EP 088,046 and EP 143,949, incorporated by reference.

Pharmaceutical compositions used for in vivo administration are typically provided as sterile preparations. Sterilization can be accomplished by filtration through sterile filtration membranes. When the composition is lyophilized, sterilization using this method may be conducted either prior to or following lyophilization and reconstitution. Compositions for parenteral administration can be stored in lyophilized form or in a solution. Parenteral compositions generally are placed into a container having a sterile access port, for example, an intravenous solution bag or vial having a stopper pierceable by a hypodermic injection needle.

Aspects of the invention includes self-buffering improved antigen binding protein formulations, which can be used as pharmaceutical compositions, as described in international patent application WO 06138181A2 (PCT/US2006/022599), which is incorporated by reference in its entirety herein.

As discussed above, certain embodiments provide improved antigen binding proteins protein compositions, particularly pharmaceutical improved antigen binding protein compositions, that comprise, in addition to the improved antigen binding protein, one or more excipients such as those illustratively described in this section and elsewhere herein. Excipients can be used in the invention in this regard for a wide variety of purposes, such as adjusting physical, chemical, or biological properties of formulations, such as adjustment of viscosity, and or processes of the invention to improve effectiveness and or to stabilize such formulations and processes against degradation and spoilage due to, for instance, stresses that occur during manufacturing, shipping, storage, pre-use preparation, administration, and thereafter.

A variety of expositions are available on protein stabilization and formulation materials and methods useful in this regard, such as Arakawa et al., “Solvent interactions in pharmaceutical formulations,” Pharm Res. 8(3): 285-91 (1991); Kendrick et al., “Physical stabilization of proteins in aqueous solution,” in: RATIONAL DESIGN OF STABLE PROTEIN FORMULATIONS: THEORY AND PRACTICE, Carpenter and Manning, eds. Pharmaceutical Biotechnology. 13: 61-84 (2002), and Randolph et al., “Surfactant-protein interactions,” Pharm Biotechnol. 13: 159-75 (2002), each of which is herein incorporated by reference in its entirety, particularly in parts pertinent to excipients and processes of the same for self-buffering protein formulations in accordance with the current invention, especially as to protein pharmaceutical products and processes for veterinary and/or human medical uses.

Salts may be used in accordance with certain embodiments of the invention to, for example, adjust the ionic strength and/or the isotonicity of a formulation and/or to improve the solubility and/or physical stability of a protein or other ingredient of a composition in accordance with the invention.

As is well known, ions can stabilize the native state of proteins by binding to charged residues on the protein's surface and by shielding charged and polar groups in the protein and reducing the strength of their electrostatic interactions, attractive, and repulsive interactions. Ions also can stabilize the denatured state of a protein by binding to, in particular, the denatured peptide linkages (—CONH) of the protein. Furthermore, ionic interaction with charged and polar groups in a protein also can reduce intermolecular electrostatic interactions and, thereby, prevent or reduce protein aggregation and insolubility.

Ionic species differ significantly in their effects on proteins. A number of categorical rankings of ions and their effects on proteins have been developed that can be used in formulating pharmaceutical compositions in accordance with the invention. One example is the Hofmeister series, which ranks ionic and polar non-ionic solutes by their effect on the conformational stability of proteins in solution. Stabilizing solutes are referred to as “kosmotropic.” Destabilizing solutes are referred to as “chaotropic.” Kosmotropes commonly are used at high concentrations (e.g., >1 molar ammonium sulfate) to precipitate proteins from solution (“salting-out”). Chaotropes commonly are used to denture and/or to solubilize proteins (“salting-in”). The relative effectiveness of ions to “salt-in” and “salt-out” defines their position in the Hofmeister series.

Free amino acids can be used in improved antigen binding protein formulations in accordance with various embodiments of the invention as bulking agents, stabilizers, and antioxidants, as well as other standard uses. Lysine, proline, serine, and alanine can be used for stabilizing proteins in a formulation. Glycine is useful in lyophilization to ensure correct cake structure and properties. Arginine may be useful to inhibit protein aggregation, in both liquid and lyophilized formulations. Methionine is useful as an antioxidant.

Polyols include sugars, e.g., mannitol, sucrose, and sorbitol and polyhydric alcohols such as, for instance, glycerol and propylene glycol, and, for purposes of discussion herein, polyethylene glycol (PEG) and related substances. Polyols are kosmotropic. They are useful stabilizing agents in both liquid and lyophilized formulations to protect proteins from physical and chemical degradation processes. Polyols also are useful for adjusting the tonicity of formulations.

Among polyols useful in select embodiments of the invention is mannitol, commonly used to ensure structural stability of the cake in lyophilized formulations. It ensures structural stability to the cake. It is generally used with a lyoprotectant, e.g., sucrose. Sorbitol and sucrose are among preferred agents for adjusting tonicity and as stabilizers to protect against freeze-thaw stresses during transport or the preparation of bulks during the manufacturing process. Reducing sugars (which contain free aldehyde or ketone groups), such as glucose and lactose, can glycate surface lysine and arginine residues. Therefore, they generally are not among preferred polyols for use in accordance with the invention. In addition, sugars that form such reactive species, such as sucrose, which is hydrolyzed to fructose and glucose under acidic conditions, and consequently engenders glycation, also is not among preferred polyols of the invention in this regard. PEG is useful to stabilize proteins and as a cryoprotectant and can be used in the invention in this regard.

Embodiments of the improved antigen binding protein formulations further comprise surfactants. Protein molecules may be susceptible to adsorption on surfaces and to denaturation and consequent aggregation at air-liquid, solid-liquid, and liquid-liquid interfaces. These effects generally scale inversely with protein concentration. These deleterious interactions generally scale inversely with protein concentration and typically are exacerbated by physical agitation, such as that generated during the shipping and handling of a product.

Surfactants routinely are used to prevent, minimize, or reduce surface adsorption. Useful surfactants in the invention in this regard include polysorbate 20, polysorbate 80, other fatty acid esters of sorbitan polyethoxylates, and poloxamer 188.

Surfactants also are commonly used to control protein conformational stability. The use of surfactants in this regard is protein-specific since, any given surfactant typically will stabilize some proteins and destabilize others.

Polysorbates are susceptible to oxidative degradation and often, as supplied, contain sufficient quantities of peroxides to cause oxidation of protein residue side-chains, especially methionine. Consequently, polysorbates should be used carefully, and when used, should be employed at their lowest effective concentration. In this regard, polysorbates exemplify the general rule that excipients should be used in their lowest effective concentrations.

Embodiments of improved antigen binding protein formulations further comprise one or more antioxidants. To some extent deleterious oxidation of proteins can be prevented in pharmaceutical formulations by maintaining proper levels of ambient oxygen and temperature and by avoiding exposure to light. Antioxidant excipients can be used as well to prevent oxidative degradation of proteins. Among useful antioxidants in this regard are reducing agents, oxygen/free-radical scavengers, and chelating agents. Antioxidants for use in therapeutic protein formulations in accordance with the invention preferably are water-soluble and maintain their activity throughout the shelf life of a product. EDTA is a preferred antioxidant in accordance with the invention in this regard.

Antioxidants can damage proteins. For instance, reducing agents, such as glutathione in particular, can disrupt intramolecular disulfide linkages. Thus, antioxidants for use in the invention are selected to, among other things, eliminate or sufficiently reduce the possibility of themselves damaging proteins in the formulation.

Formulations in accordance with the invention may include metal ions that are protein co-factors and that are necessary to form protein coordination complexes, such as zinc necessary to form certain insulin suspensions. Metal ions also can inhibit some processes that degrade proteins. However, metal ions also catalyze physical and chemical processes that degrade proteins.

Magnesium ions (10-120 mM) can be used to inhibit isomerization of aspartic acid to isoaspartic acid. Ca⁺² ions (up to 100 mM) can increase the stability of human deoxyribonuclease. Mg⁺², Mn⁺², and Zn⁺², however, can destabilize rhDNase. Similarly, Ca⁺² and Sr⁺² can stabilize Factor VIII, it can be destabilized by Mg⁺², Mn⁺² and Zn⁺², Cu⁺² and Fe⁺², and its aggregation can be increased by Al⁺³ ions.

Embodiments of improved antigen binding protein formulations further comprise one or more preservatives. Preservatives are necessary when developing multi-dose parenteral formulations that involve more than one extraction from the same container. Their primary function is to inhibit microbial growth and ensure product sterility throughout the shelf-life or term of use of the drug product. Commonly used preservatives include benzyl alcohol, phenol and m-cresol. Although preservatives have a long history of use with small-molecule parenterals, the development of protein formulations that includes preservatives can be challenging. Preservatives almost always have a destabilizing effect (aggregation) on proteins, and this has become a major factor in limiting their use in multi-dose protein formulations. To date, most protein drugs have been formulated for single-use only. However, when multi-dose formulations are possible, they have the added advantage of enabling patient convenience, and increased marketability. A good example is that of human growth hormone (hGH) where the development of preserved formulations has led to commercialization of more convenient, multi-use injection pen presentations. At least four such pen devices containing preserved formulations of hGH are currently available on the market. Norditropin (liquid, Novo Nordisk), Nutropin AQ (liquid, Genentech) & Genotropin (lyophilized—dual chamber cartridge, Pharmacia & Upjohn) contain phenol while Somatrope (Eli Lilly) is formulated with m-cresol.

Several aspects need to be considered during the formulation and development of preserved dosage forms. The effective preservative concentration in the drug product must be optimized. This requires testing a given preservative in the dosage form with concentration ranges that confer anti-microbial effectiveness without compromising protein stability.

As might be expected, development of liquid formulations containing preservatives are more challenging than lyophilized formulations. Freeze-dried products can be lyophilized without the preservative and reconstituted with a preservative containing diluent at the time of use. This shortens the time for which a preservative is in contact with the protein, significantly minimizing the associated stability risks. With liquid formulations, preservative effectiveness and stability should be maintained over the entire product shelf-life (.about.18 to 24 months). An important point to note is that preservative effectiveness should be demonstrated in the final formulation containing the active drug and all excipient components.

Improved antigen binding protein formulations generally will be designed for specific routes and methods of administration, for specific administration dosages and frequencies of administration, for specific treatments of specific diseases, with ranges of bio-availability and persistence, among other things. Formulations thus may be designed in accordance with the invention for delivery by any suitable route, including but not limited to orally, aurally, opthalmically, rectally, and vaginally, and by parenteral routes, including intravenous and intraarterial injection, intramuscular injection, and subcutaneous injection.

Once the pharmaceutical composition has been formulated, it may be stored in sterile vials as a solution, suspension, gel, emulsion, solid, crystal, or as a dehydrated or lyophilized powder. Such formulations may be stored either in a ready-to-use form or in a form (e.g., lyophilized) that is reconstituted prior to administration. The invention also provides kits for producing a single-dose administration unit. The kits of the invention may each contain both a first container having a dried protein and a second container having an aqueous formulation. In certain embodiments of this invention, kits containing single and multi-chambered pre-filled syringes (e.g., liquid syringes and lyosyringes) are provided.

The therapeutically effective amount of a improved antigen binding protein-containing pharmaceutical composition to be employed will depend, for example, upon the therapeutic context and objectives. One skilled in the art will appreciate that the appropriate dosage levels for treatment will vary depending, in part, upon the molecule delivered, the indication for which the improved antigen binding protein is being used, the route of administration, and the size (body weight, body surface or organ size) and/or condition (the age and general health) of the patient. In certain embodiments, the clinician may titer the dosage and modify the route of administration to obtain the optimal therapeutic effect.

Pharmaceutical compositions may be administered using a medical device. Examples of medical devices for administering pharmaceutical compositions are described in U.S. Pat. Nos. 4,475,196; 4,439,196; 4,447,224; 4,447, 233; 4,486,194; 4,487,603; 4,596,556; 4,790,824; 4,941,880; 5,064,413; 5,312,335; 5,312,335; 5,383,851; and 5,399,163, all incorporated by reference herein.

### EXAMPLES

### Example 1

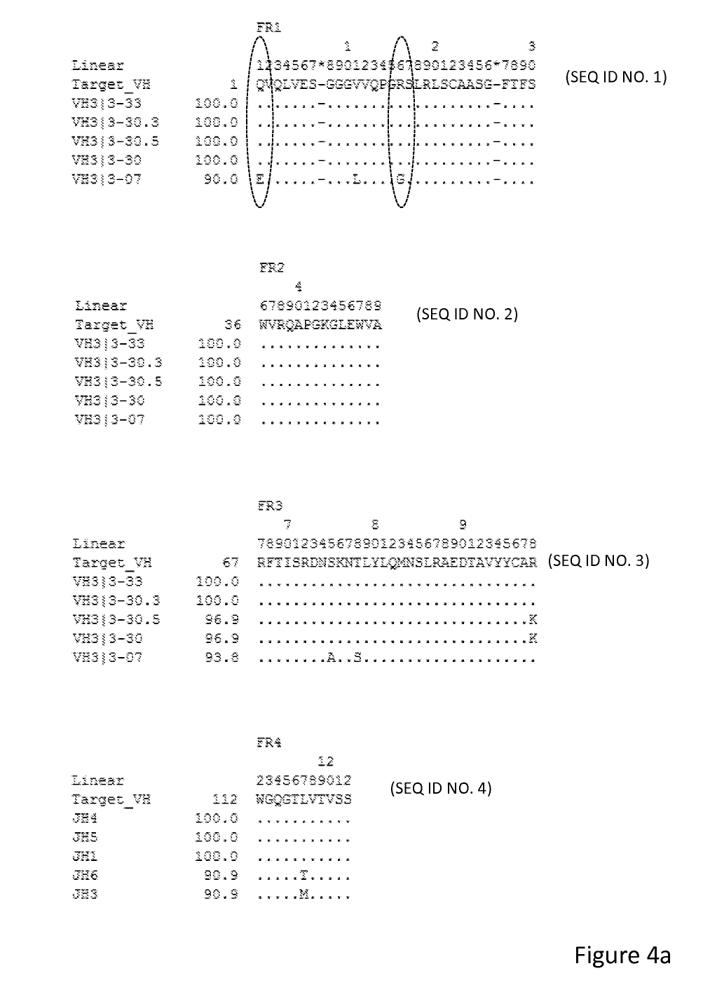

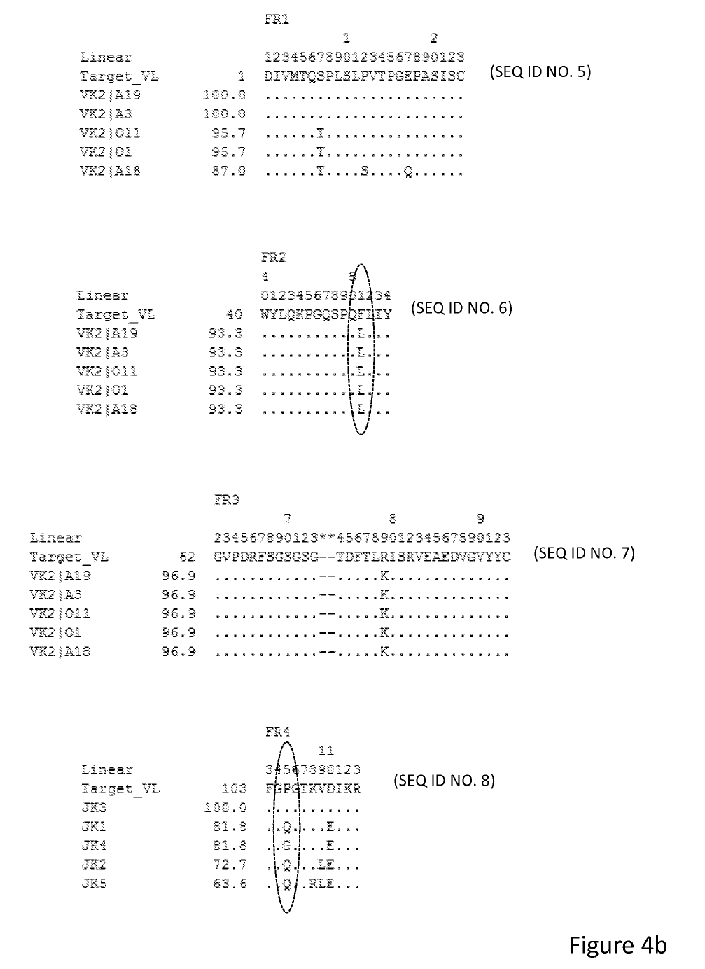

In this example, a poorly expressing antibody 1 with lower thermal stability is engineered to increase the expression level in transiently transfected cells along with improved thermal stability. FIG. 4a shows the alignment of antibody 1 sequence with human germline sequences. Only the top 5 closely related, as identified by the percentage of sequence identity to the antibody 1, human germline sequences are shown in this figure. Based on this, the possible subtype of the antibody 1 is determined In this case, the variable heavy chain of the antibody 1 sequence belongs to the VH3 subtype and the variable light chain belongs to the VK2 subtype. In the next step, the antibody 1 variable light and the variable heavy chain sequences were aligned against the VK2 and VH3 sequences found in the Kabat database (Wu and Kabat 1970), respectively. In order to the identify amino acids pairs that undergo correlated mutations in the multiple sequence alignments, the twenty amino acids were classified into 6 groups based on their physiochemical properties—small hydrophobic, aromatic, polar neutral, positively charged, negatively charged, and deletion/glycine. A conservation score was then calculated as discussed before. The identified conserved pairs were examined at 60 to 90% cutoff level. Typically, 60% is used as lower cutoff level and often a higher threshold value implies greater significance.

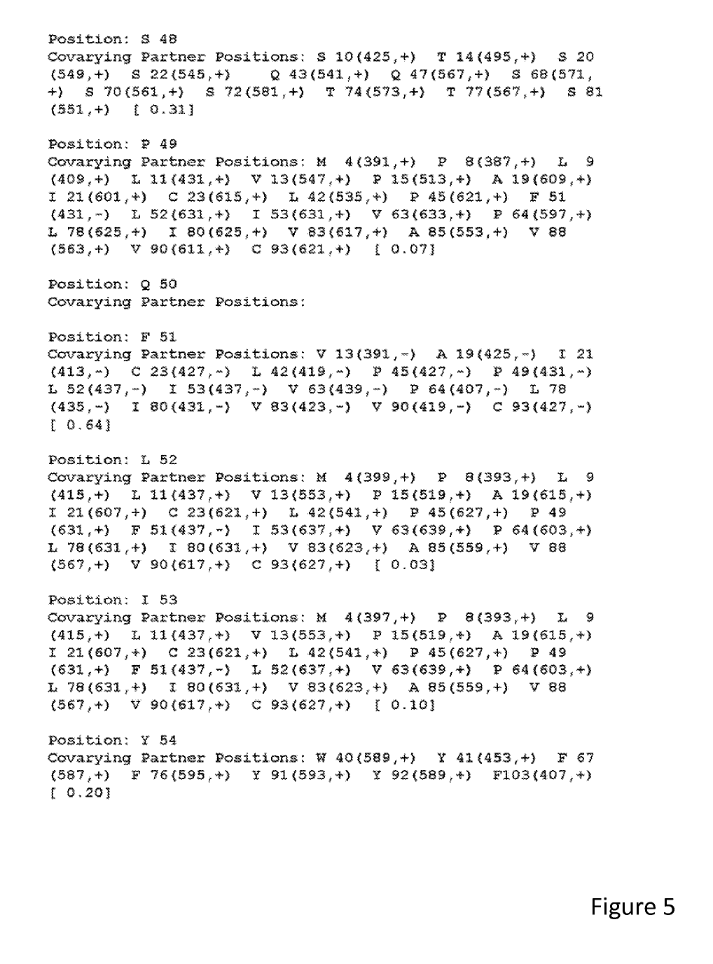

The target antibody 1 sequence was then examined to see if the identified correlated mutational pairs are correlated or not. The positions in the antibody 1 sequence that deviate from the observed pattern of correlated pair-wise conservation were marked for mutations. For example, the position F51 in the light chain of the antibody sequence 1 is not correlated (violation) to positions V13, A19, I21, C23, L42, P45, P49, L52, I53, V63, P64, L78, I80, V83, V90, and C93 (FIG. 5). The position F51 in the antibody 1 sequence is aromatic and the partner positions are small hydrophobic in nature. This implies that in order to fix the violations, the position F51 should be substituted with a small hydrophobic amino acids. In order to identify the small hydrophobic residue to be substituted with, residues found at the equivalent position of F51 in the closely related germline sequences were examined as shown FIG. 4b. Further, frequencies of residues found at the equivalent position of F51 in the kabat/IMGT databases were also taken into account. It is clear from the FIG. 4b, that the position F51 should be mutated to Leu. And, the residue Leu is most frequent (69%) at this position in the database. Further, modeled structure of the variable domain antibody 1 was examined to make sure F51L mutation did not cause any obvious structural issues (such as steric hinderance, disrupting hydrogen bond, introducing polar amino acids at the buried core region, etc).

In order to identify the violations at the VL/VH interface, the amino acid pairs involved in the domain-domain interaction were identified based on the modeled structure of the variable domain. Two residues are considered to be interacting if any side chain heavy atom of the first residue is within 6.5 Angstrom from any side chain heavy atom of the second residue. And then the multiple sequence alignment was examined the same way as in the case of individual chains.

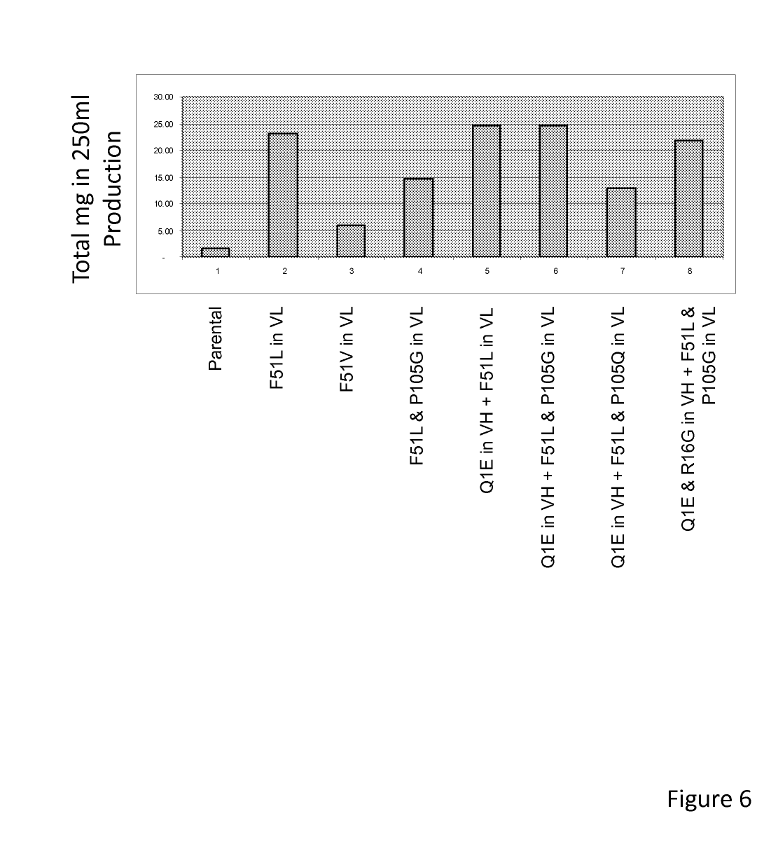

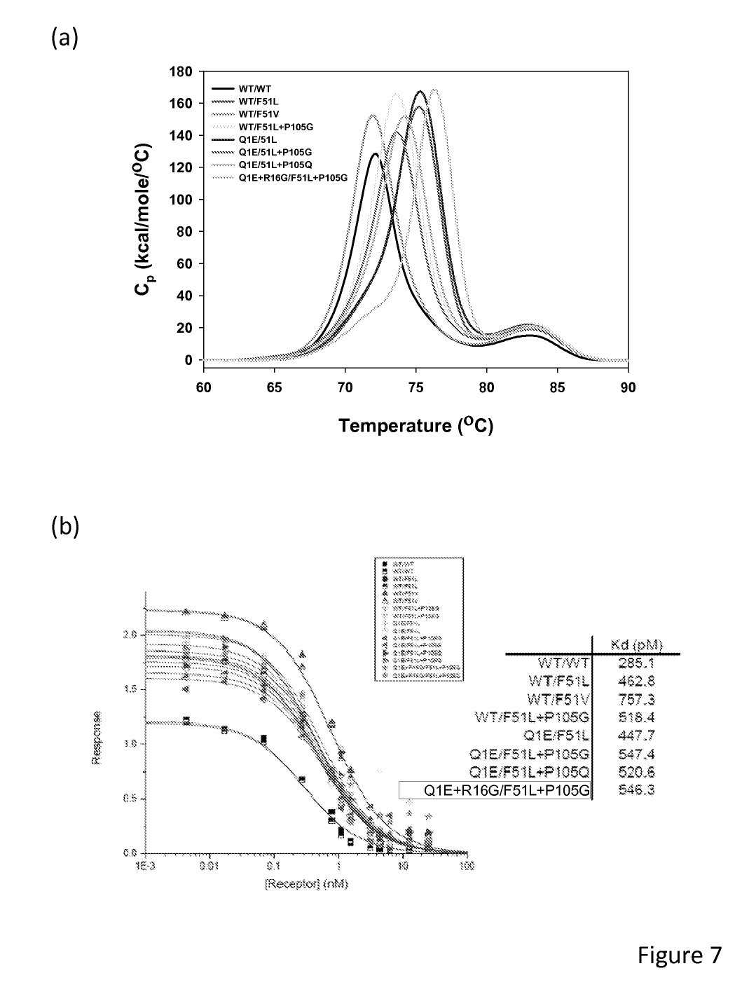

There were three more violations in this antibody 1 sequence at position P105 in the light chain and Q1 and R16 position in the heavy chain. Those violations were fixed as discussed in the F51 case. The transient expression levels for the designed constructs are shown in the FIG. 6. The parental antibody is a very poor expressor (2 to 3 mg/L). All of the designed constructs showed higher expression level compared to the parental. FIG. 7a shows the thermal stability profiles as determined through Differential Scanning calorimetery. All of the designed constructs show equal or higher thermal stability, in both melting temperature (transition point) and enthalpy (area under the curve). In particular, the construct that has all the violations fixed shows highest improvement in thermal stability (in both melting temperature and enthalpy). FIG. 7b shows binding profiles for the all the designed constructs. As can be seen, the affinities of the variants as determined by Kinexa® assay are within 2-fold difference with the parental.

### Example 2

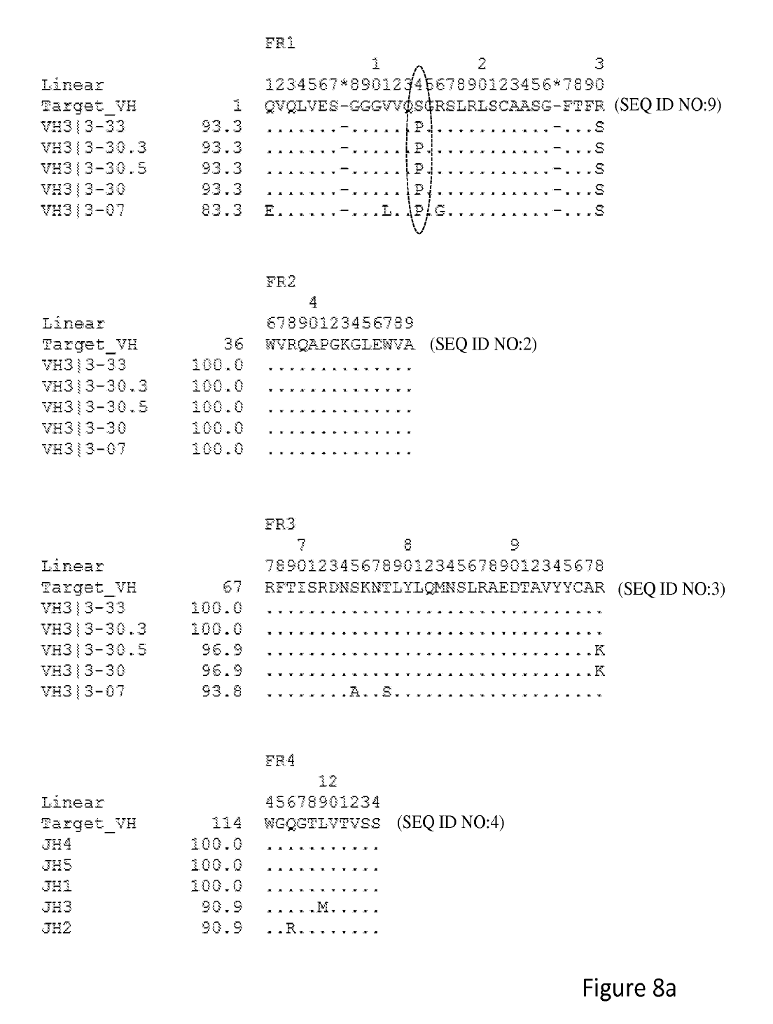

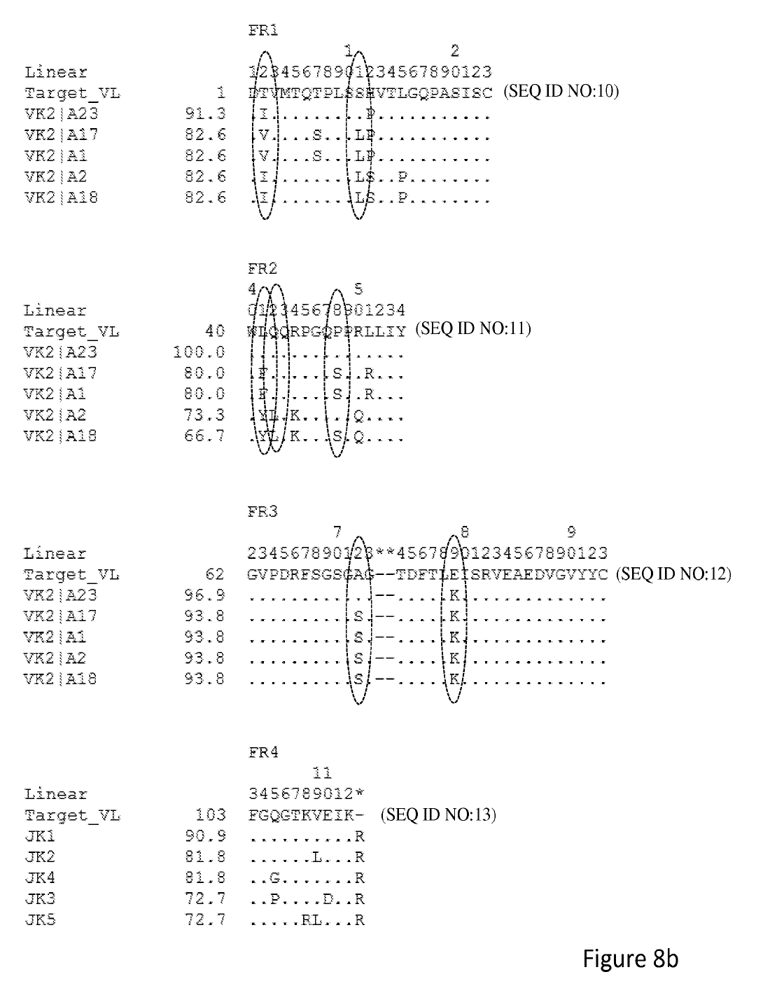

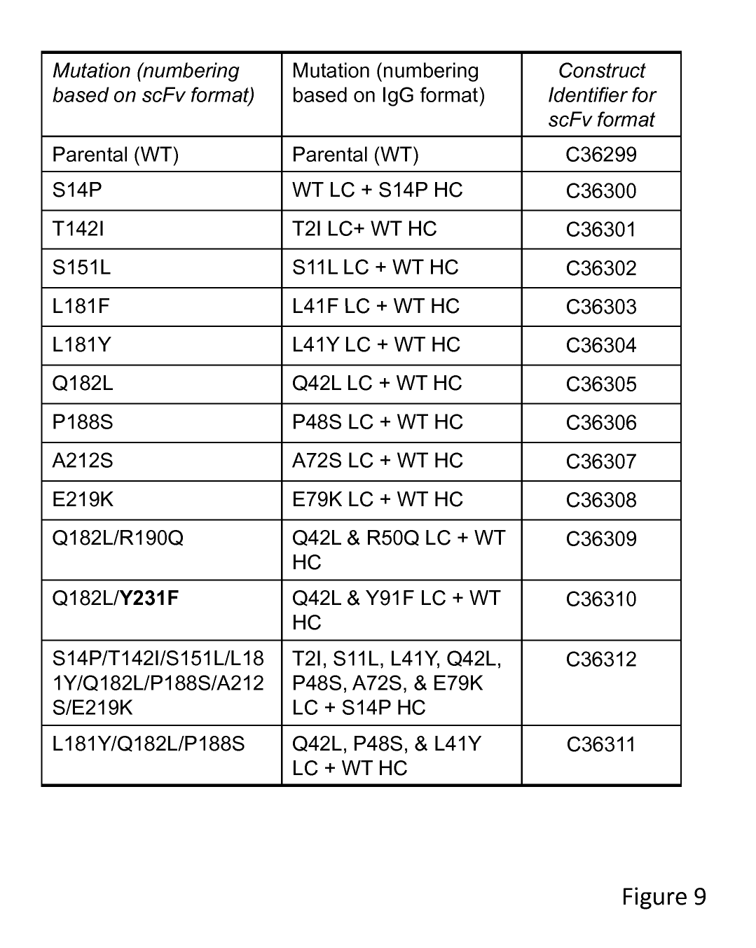

Antibody 2 against another target is a poorly expressing molecule with lower thermal stability. In addition, high level of aggregation is noted when this IgG antibody is converted to scFv-Fc format. Correlated mutational analysis was carried out as in the case of Example 1. A total of 8 violations were identified in the framework region of the antibody 2 sequence (FIG. 8). The designed constructs of point mutants and combination of point mutants are listed in FIG. 9. It must be noted here that Y231F mutation was identified through antibody modeling and structural analysis. All other mutations were identified through correlated mutational analysis.

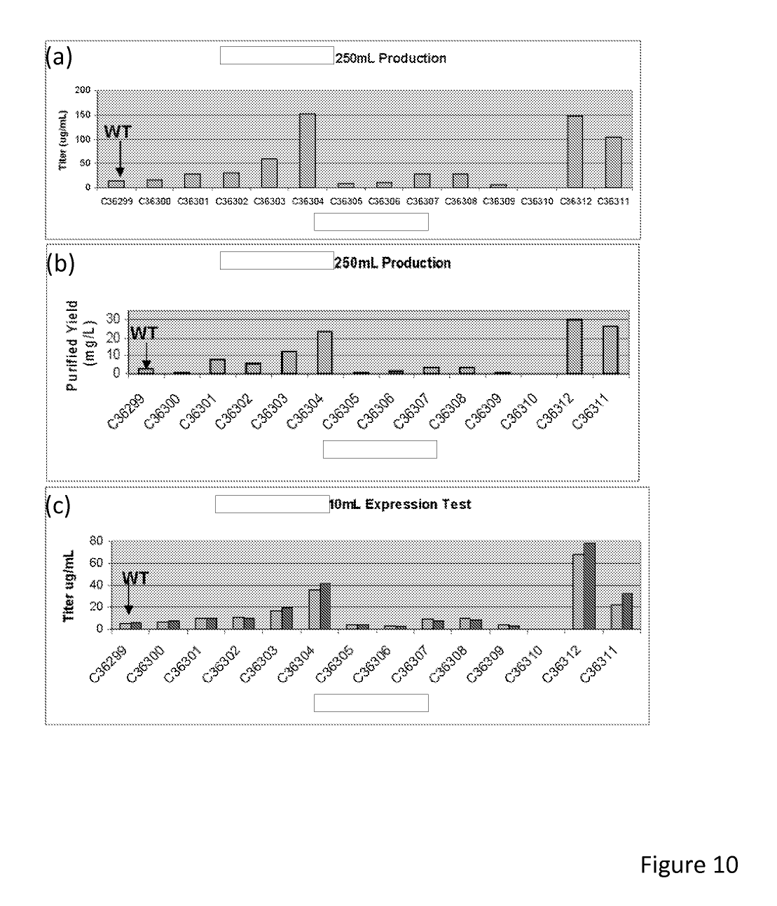

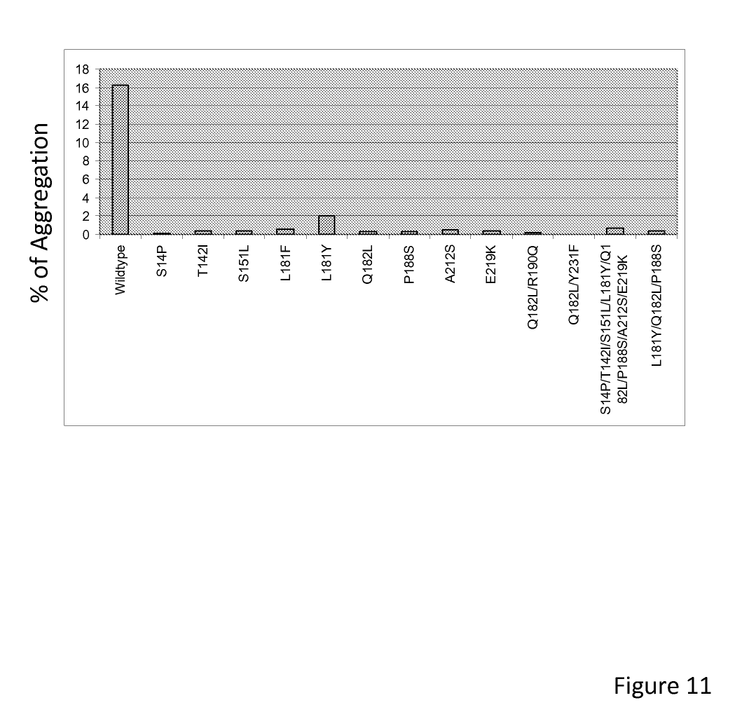

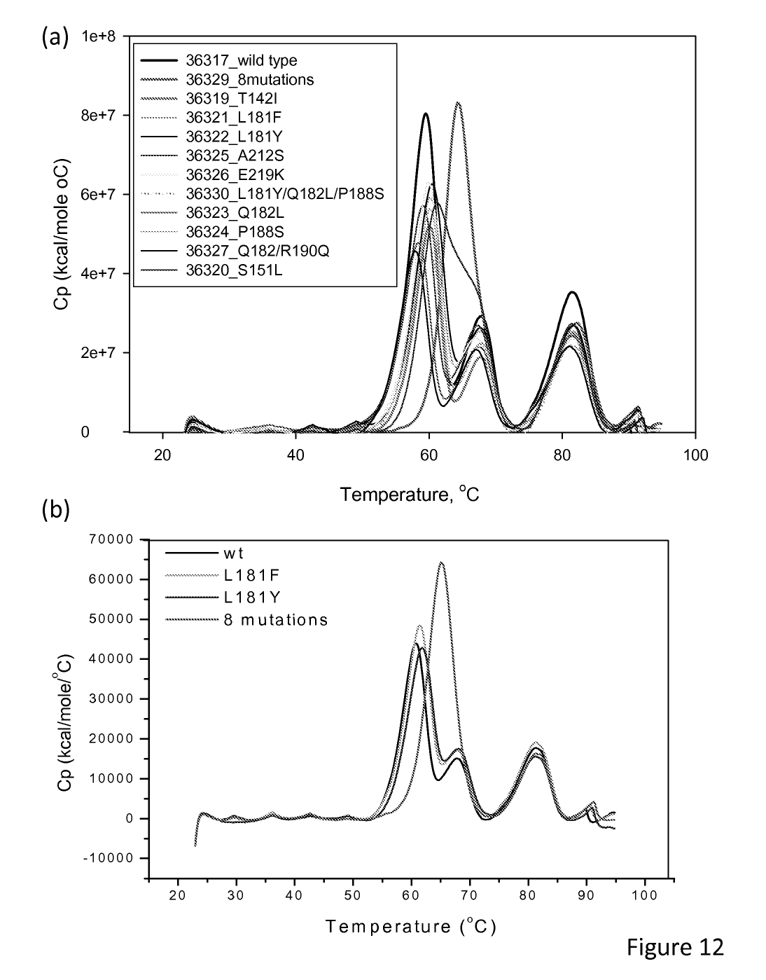

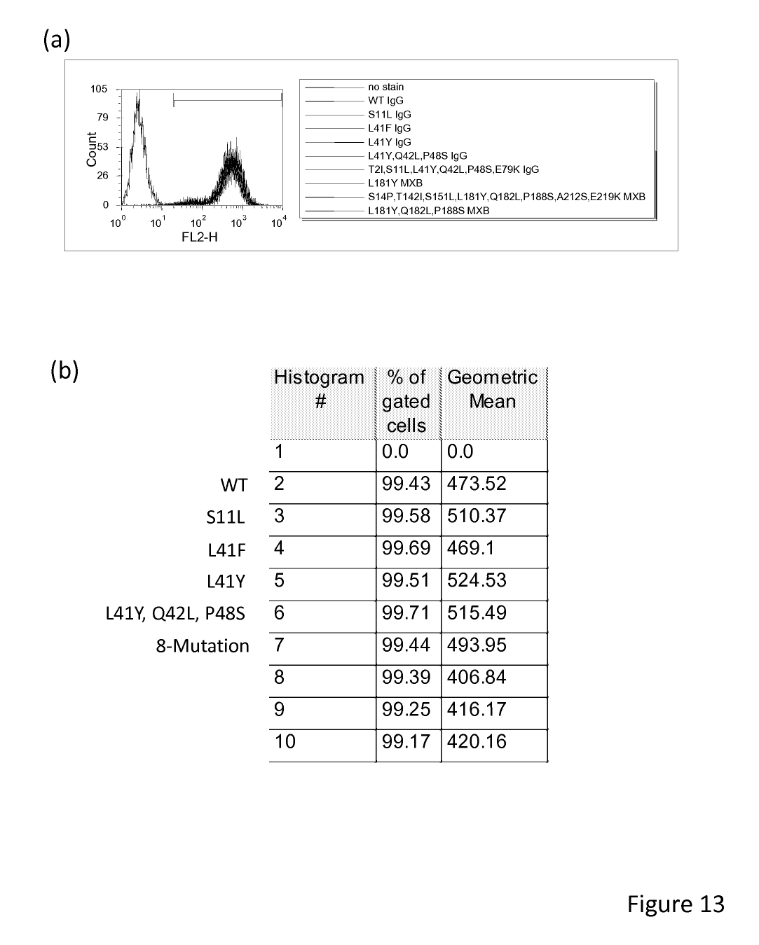

FIG. 10 shows the transient expression levels of the antibody 2 and its variants in scFv-Fc format. FIG. 10a shows the titer level as determined by protein A binding, 10b shows the purified yield (mg/L) and (c) shows the repeated expression tests at 10 ml scale. Except the variant involving Y231F mutation, which was determined through modeling and structural analysis, all other variants expressed similar or better than the parental molecule. In particular the variant that had all the violations fixed (a total of 8 mutations) showed highest improvement in the expression level. FIG. 11 shows the aggregation levels, as determined by Size Exclusion Chromatography, of the parental and the variants. All the variants showed much lower level of aggregation as compared to the parental molecule. FIG. 12a shows the thermal stability profiles of the parental and the variants in the scFv-Fc format. FIG. 12b shows the thermal stability profiles the parental and the selected variants in the IgG format. The construct that has all the violations fixed showed highest improvement in the thermal stability (both Tm and enthalpy is increased). FIG. 13 shows the FACS based binding analysis. As can be seen, all the variants exhibited similar binding profile.

### Example 3

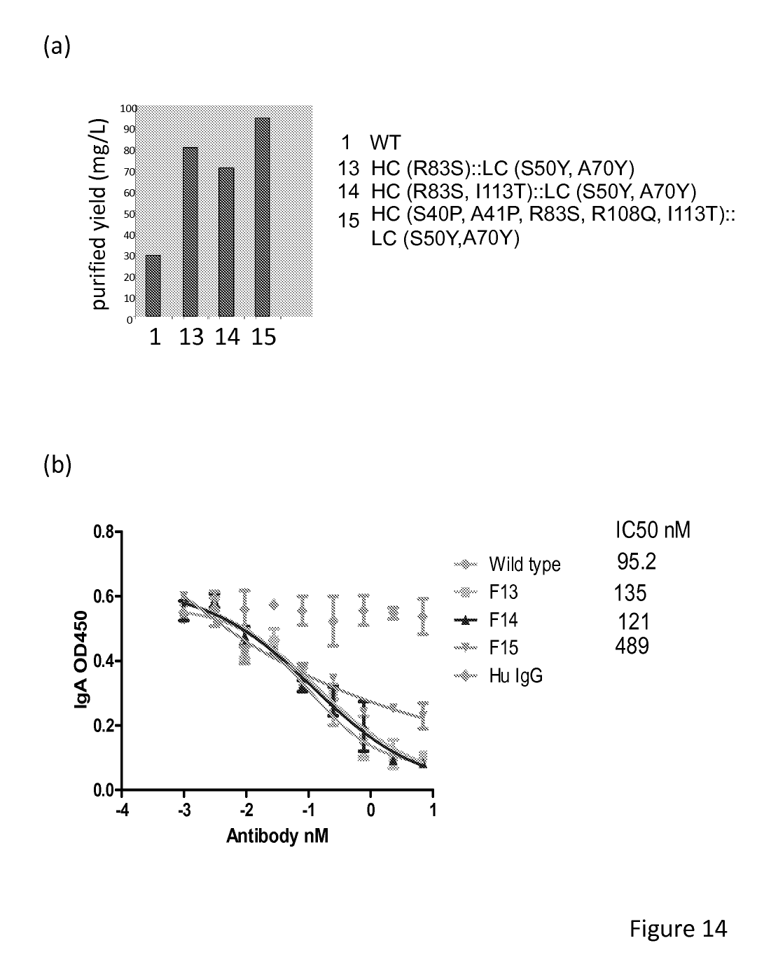

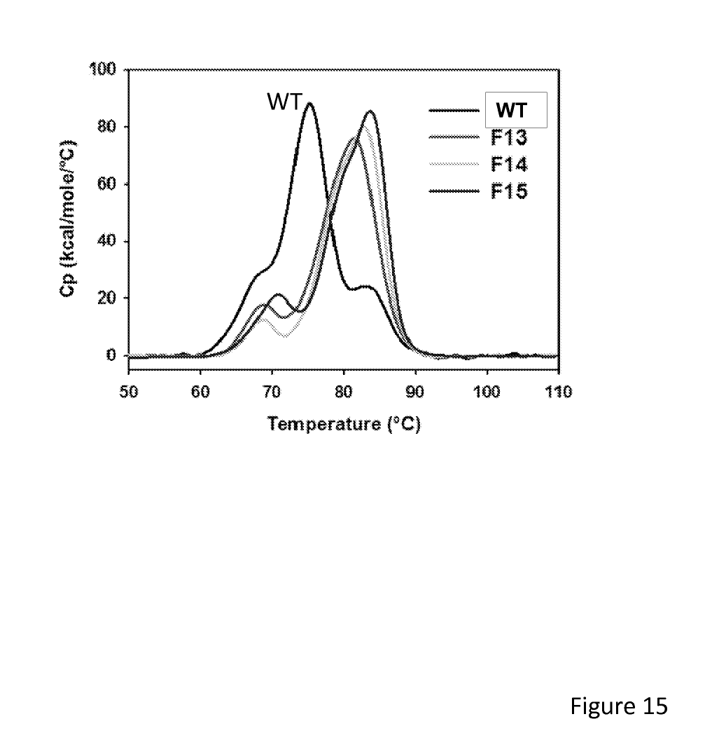

This is an example dealing with an antibody that expresses moderately well (30-50 mg/L in transient transfection in 293 cells). Correlated mutational analysis was carried out as in the above examples. A total of 6 violations were identified in this case. The transient expression levels of the parental and its variants which were designed based on the correlated mutational analysis are shown in the FIG. 14. Here again, the construct that had all the violations fixed showed highest improvement in the expression. FIG. 14b shows the inhibition analysis of the variants. The construct that had the maximum number of mutations showed about a 5-fold decrease in inhibition. This was most likely due to the two charge mutations that are located close to the CDR surface. Nevertheless, in this example too, the construct that had maximum number of mutations showed highest improvement in thermal stability (FIG. 15). More importantly, the variants were less sensitive to the pH variation of the formulation buffer. The parental molecules formed a gel, when the pH was increased from 5.2 to 7.4. Unlike the parental, the variant (F15) did not precipitate when the pH was increased from 5.2 to 7.4.

### Example 4

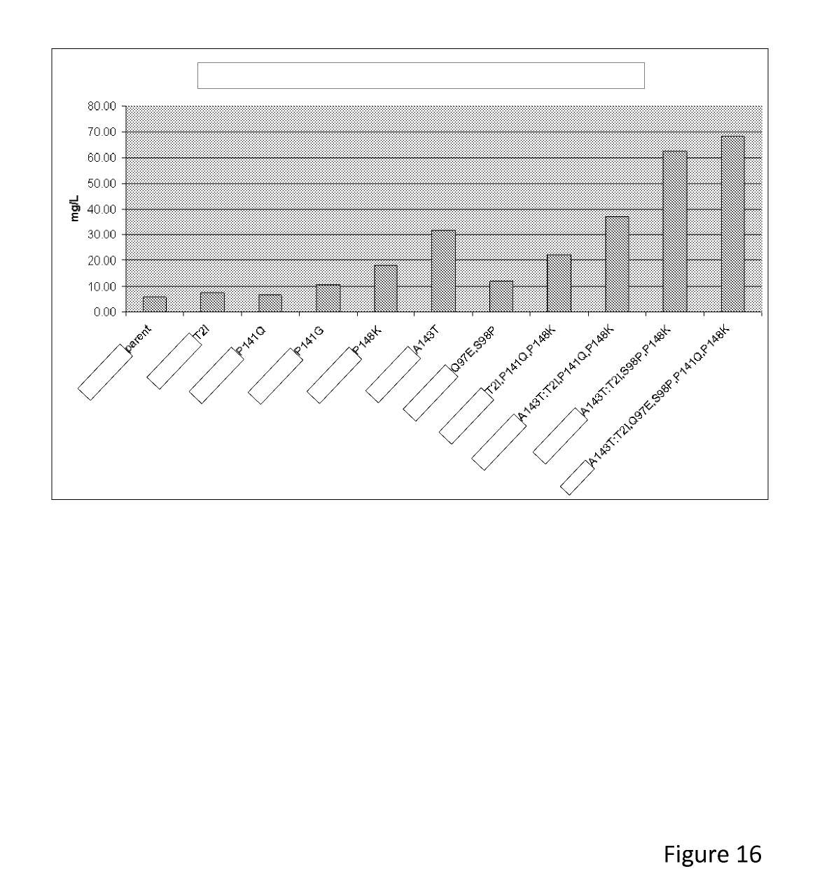

In this example, a poorly expressing antibody was analyzed through correlated mutational analysis. As with previous cases, suggested mutations led to improvement in the expression within transiently transfected 293 cells. The construct that has the maximum number of mutations expressed 10-fold better than the parental (FIG. 16).

### REFERENCES

Deisenhofer, J. 1981. Crystallographic refinement and atomic models of a human Fc fragment and its complex with fragment B of protein A from Staphylococcus aureus at 2.9- and 2.8-A resolution. Biochemistry 20: 2361-2370.
Gunasekaran, K., Hagler, A. T., and Gierasch, L. M. 2004. Sequence and structural analysis of cellular retinoic acid-binding proteins reveals a network of conserved hydrophobic interactions. Proteins 54: 179-194.
Higgins, D. G., and Sharp, P. M. 1988. CLUSTAL: a package for performing multiple sequence alignment on a microcomputer. Gene 73: 237-244.
Honegger, A. 2008. Engineering antibodies for stability and efficient folding. Handb Exp Pharmacol: 47-68.
Huber, R. 1984. Three-dimensional structure of antibodies. Behring Institute Mitteilungen: 1-14.
Jung, S., Honegger, A., and Pluckthun, A. 1999. Selection for improved protein stability by phage display. Journal of molecular biology 294: 163-180.
Martin, W. L., West, A. P., Jr., Gan, L., and Bjorkman, P. J. 2001. Crystal structure at 2.8 A of an FcRn/heterodimeric Fc complex: mechanism of pH-dependent binding. Molecular cell 7: 867-877.
Monsellier, E., and Bedouelle, H. 2006. Improving the stability of an antibody variable fragment by a combination of knowledge-based approaches: validation and mechanisms. Journal of molecular biology 362: 580-593.
Papadea, C., and Check, I. J. 1989. Human immunoglobulin G and immunoglobulin G subclasses: biochemical, genetic, and clinical aspects. Critical reviews in clinical laboratory sciences 27: 27-58.
Roux, K. H. 1999. Immunoglobulin structure and function as revealed by electron microscopy. International archives of allergy and immunology 120: 85-99.
Wang, N., Smith, W. F., Miller, B. R., Aivazian, D., Lugovskoy, A. A., Reff, M. E., Glaser, S. M., Croner, L. J., and Demarest, S. J. 2009. Conserved amino acid networks involved in antibody variable domain interactions. Proteins 76: 99-114.
Worn, A., and Pluckthun, A. 2001. Stability engineering of antibody single-chain Fv fragments. Journal of molecular biology 305: 989-1010.
Wu, T. T., and Kabat, E. A. 1970. An analysis of the sequences of the variable regions of Bence Jones proteins and myeloma light chains and their implications for antibody complementarity. The Journal of experimental medicine 132: 211-250.

1. A method of improving one or more characteristics of an antigen binding protein comprising an antibody variable domain of interest, said method comprising:
a) identification of pair-wise conserved residue positions within a variable domain framework based on a physiochemical property of the residues;
b) determining how the antibody variable domain of interest framework amino acid sequence deviates from the pair-wise conserved residue positions identified in a);
c) substituting one or more amino acid residues determined to be deviations from b) with amino acids found at equivalent positions in germline or related-germline sequences.

2. The method of claim 1, wherein pair-wise conserved residues are identified by:
i) assigning a germline subtype to the antibody variable domain of interest;
ii) aligning framework regions of multiple variable domains belonging to the germline subtype identified in (i);
iii) classifying the amino acid at each position within an aligned variable domain as small hydrophobic, aromatic, neutral polar, positively charged, negatively charged, or glycine/deletion;
iv) calculating a conservation score for each pair-wise position; and
v) determining correlated mutational pairs based on a threshold calculation.

3. The method of claim 2, wherein the conservation score equals number of pairs belonging to the same classification and subtract that sum with number of pairs belonging to a different classification.

4. The method of claim 1, wherein deviations within the antibody variable domain of interest are determined by comparing amino acids pairs in the sequence of interest with observed pattern of pair-wise conserved residue positions that are identified using the multiple sequence alignment of known variable domain sequences and the threshold calculation.

5. The method of claim 1, wherein one or more amino acid residues determined to be deviations are substituted with an amino acid found at that position in the germline sequence.

6. The method of claim 5, wherein all the deviations are substituted with an amino acid found at that position in the germline sequence.

7. The method of claim 1, wherein one or more amino acid residues determined to be deviations are substituted with an amino acid found at that position in a related-germline sequence.

8. The method of claim 7, wherein all the deviations are substituted with an amino acid found at that position in a related-germline sequence.

9. The method of claim 1, wherein all the deviations are substituted with an amino acid found at that position in a germline sequence or a related-germline sequence.

10. The method of claim 1, wherein the antigen binding protein comprises a heavy chain variable domain and a light chain variable domain.

11. The method of claim 10, wherein the heavy chain variable domain is a human heavy chain variable domain and the light chain variable domain is a human light chain variable domain.

12. (canceled)

13. The method of claim 10, wherein the antigen binding protein is an antibody.

14. The method of claim 13, wherein the antigen binding protein is a human antibody.

15. The method of claim 10, wherein the antigen binding protein comprises an scFv.

16. The method of claim 1, wherein expression of the antigen binding protein is improved.

17. The method claim 1, wherein thermal stability of the antigen binding protein is improved.

18. An antigen binding protein improved by the method of claim 1.

19. An isolated nucleic acid encoding an antibody variable domain of an antigen binding protein improved by the method of claim 1, wherein said method comprises substituting one or more residues within the antibody variable domain with a germline or related-germline residue.

20. A host cell comprising the isolated nucleic acid of claim 19.


SEQUENCE LISTING (13 sequences)

SEQ ID NO: 1 - protein, 30 aa, Homo sapiens
QVQLVESGGGVVQPGRSLRLSCAASGFTFS

SEQ ID NO: 2 - protein, 14 aa, Homo sapiens
WVRQAPGKGLEWVA

SEQ ID NO: 3 - protein, 32 aa, Homo sapiens
RFTISRDNSKNTLYLQMNSLRAEDTAVYYCAR

SEQ ID NO: 4 - protein, 11 aa, Homo sapiens
WGQGTLVTVSS

SEQ ID NO: 5 - protein, 23 aa, Homo sapiens
DIVMTQSPLSLPVTPGEPASISC

SEQ ID NO: 6 - protein, 15 aa, Homo sapiens
WYLQKPGQSPQFLIY

SEQ ID NO: 7 - protein, 32 aa, Homo sapiens
GVPDRFSGSGSGTDFTLRISRVEAEDVGVYYC

SEQ ID NO: 8 - protein, 11 aa, Homo sapiens
FGPGTKVDIKR

SEQ ID NO: 9 - protein, 30 aa, Homo sapiens
QVQLVESGGGVVQSGRSLRLSCAASGFTFR

SEQ ID NO: 10 - protein, 24 aa, Homo sapiens
DTVMTQTPLSSHVTLGQPASISSC

SEQ ID NO: 11 - protein, 15 aa, Homo sapiens
WLQQRPGQPPRLLIY

SEQ ID NO: 12 - protein, 32 aa, Homo sapiens
GVPDRFSGSGAGTDFTLEISRVEAEDVGVYYC

SEQ ID NO: 13 - protein, 10 aa, Homo sapiens
FGQGTKVEIK